(19) United States
(12) Patent Application Publication
(10) Pub. No.: US 2009/0198000 A1
(43) Pub. Date: Aug. 6, 2009

(54) Liquid fluorine-containing and two-component compositions for the surface treatment of mineral and non-mineral substrates

(75) Inventors: Frank Weinelt, Billerbeck (DE); Alois Maier, Engelsberg (DE); Norbert Steidl, Kienberg (DE); Michael Schroers, Ludwigshafen am Rhein (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/362,921

(22) Filed: Jan. 30, 2009

(30) Foreign Application Priority Data
Feb. 1, 2008 (EP) EP08101211

(51) Int. Cl. C08K 5/5419

(52) U.S. Cl. 524/188

(57) ABSTRACT

Fluorine-containing and two-component compositions exhibit improved surface properties for the permanent oil- and water-repellent surface treatment or modification of mineral and non-mineral substrates for various fields of application. At a simultaneously reduced fluorine content, these compositions have considerably improved application properties and, in combination with suitable stabilizing components and hydrophilic silane components, they exhibit excellent hydrophobic, oleophobic and soil-repellent properties, having overall excellent storage stability.

### BACKGROUND OF THE INVENTION

1. Field of the Invention

The present invention relates to a liquid fluorine-containing and two-component composition for the surface treatment of mineral and non-mineral substrates.

2. Description of the Related Art

Fluorine-containing organosilanes and their cocondensates or polycondensates which can be used for the simultaneous hydrophobicization and oleophobicization of mineral and non-mineral substrates are adequately known, for example, from EP 0 846 715 A1, EP 846 716 A1, EP 846 717 A1 and EP 0 960 921 A1, DE-A 199 55 047, DE-C 83 40 02, U.S. Pat. No. 3,013,066, GB 935 380, DE-A 31 00 655, EP 0 382 557 A1, EP 0 493 747 B1, EP 0 587 667 B1 and DE-A 195 44 763.

The cited specifications EP 0 846 715 A1, EP 846 716 A1, EP 846 717 A1, EP 0 960 921 and DE-A 199 55 047 describe water- and/or alcohol-based (per)fluoroalkyl-functional organopolysiloxanes which are based on (per)fluoroalkyl-functional organosilanes. The described (per)fluoroalkyl-functional organosilanes such as, for example, tridecafluoro-1,1,2,2-tetrahydrooctyltrimethoxysilane and tridecafluoro-1,1,2,2-tetrahydrooctyltriethoxysilane are only accessible via industrially complex hydrosilylation reactions of trialkoxysilanes onto unsaturated compounds, for example onto (per)fluoroalkylalkenes.

Since the industrial availability of the (per)fluoroalkylalkenes and thus of the (per)fluoroalkyl-functional organosilanes is limited, there was the need for alternative fluorine-containing compositions which, with regard to the (per)fluoroalkyl component, permit a relatively large synthetic bandwidth and at the same time can be prepared more cost-effectively than the known systems. In construction chemistry in particular, there is a need for cost-effective, high-performance and widely usable hydrophobicization and oleophobicization compositions for building production.

(Per)fluoroalkyl-functional organosilanes are not usually used in concentrated form since these are extraordinarily costly products. Furthermore, (per)fluoroalkyl-functional organosilanes are not soluble in water.

In order to obtain adequately stable solutions or preparations of (per)fluoroalkyl-functional organosilanes and their cocondensates or polycondensates, organic solvents or else emulsifiers have been used (for example DE-A 34 47 636, DE-C 36 13 384, WO 95/23830 A1, WO 95/2 3804 μl, WO 96/06895 A1, WO 97/23432 A1, EP 0 846 716 A1).

One disadvantage of solvent- or emulsifier-containing preparations of (per)fluoroalkyl-functional organosilanes and of (per)fluoroalkyl-functional organopolysiloxanes with a high fraction of alkoxy groups is that such systems are undesired for reasons of occupational safety and because of ecological aspects. Attempts have therefore increasingly been made to provide water-based systems with the lowest possible fraction of volatile, organic compounds (VOC). An advantage of further developed 2-component systems may of course also be an improved effect.

Nitrogen-containing or aminoalkyl- and (per)fluoroalkyl-functional and essentially alkoxy-group-free organopolysiloxanes are known as water-soluble constituents in otherwise emulsifier- or surfactant-free compositions for the oil-, water- and soil-repellent finishing of surfaces (for example DE-A 15 18 551, EP 0 738 771 A1, EP 0 846 717 A1).

In the case of the stated water-based systems, a relatively high fraction of amino groups or protonated amino groups must always be realized in order to ensure good solubility in water, although this has proven counterproductive in practice:

This is because, the hydrophilicity of the amino groups or protonated amino groups counteracts the endeavour to provide a system which has the most hydrophobic properties possible.

Furthermore, the oxidation sensitivity (amine oxide formation) of the amino groups or protonated amino groups causes a firing of the finished surfaces, which leads to aesthetic impairment.

### DETAILED DESCRIPTION OF THE INVENTION

It was an object of the present invention to develop novel types of fluorine-containing compositions with improved surface properties for the permanent oil- and water-repellent surface treatment or modification of mineral and non-mineral substrates for various fields of application which do not have the stated disadvantages of the background art, but have very good application properties and at the same time can be prepared with consideration of ecological, economic and physiological aspects.

This object and other objects were achieved according to the invention through the provision of liquid fluorine-containing and two-component compositions with a fluorine content, based on the solid resin, of from 5 to 75% by weight (including all values and subvalues therebetween) for the permanent surface treatment of porous and nonporous substrates, obtainable by firstly
a) preparing a fluorosilane component (A)(i) with a polymerically bonded fluorine content of from 5 to 95% by weight (including all values and subvalues therebetween) and a polymerically bonded silicon content of from 95 to 5% (including all values and subvalues therebetween) by weight, by reacting
   a₁) 5 to 95% (including all values and subvalues therebetween) by weight of a (per)fluoroalkyl alcohol component (B)(i) and/or a (per)fluoroalkylalkylenamine component (B)(ii), consisting of perfluoroalkyl alcohols with terminal methylene groups (hydrocarbon spacers) of the general formula

CF₃—(CF₂)ₓ—(CH₂)_{y}—O-A_{z}-H

or

CR₃—(CR₂)ₓ—(CH₂)_{y}—O-A_{z}-H

in which x=3-20, y=1-6, z=0-100, R=independently of one another H, F, CF₃, A=CRⁱRⁱⁱ—RⁱⁱⁱR^{iv}—O or (CRⁱRⁱⁱ)ₐ—O or CO—(CRⁱRⁱⁱ)_{b}—O where Rⁱ, Rⁱⁱ, Rⁱⁱⁱ, R^{iv}=independently of one another H, alkyl, cycloalkyl, aryl or any desired organic radical having in each case 1-25 carbon atoms, a, b=3-5, where the polyalkylene oxide structural unit A_{z} is homopolymers, copolymers or block copolymers of any desired alkylene oxides or is polyoxyalkylene glycols or polylactones,
and/or
a hexafluoropropene oxide (HFPO) oligomer alcohol of the general formula

CF₃—CF₂—CF₂—[O—CF(CF₃)—CF₂]ₓ—O—CF(CF₃)—(CH₂)_{y}—O-A_{z}-H

and/or

a fluorine-modified macromonomer or telechel (B)(iii), such as, for example, hydroxy-functional reaction products of components (F)(i) and (F)(ii) with components (O)(i) and (Q)(ii), having a polymerically bonded fluorine content of from 1 to 99% by weight (including all values and subvalues therebetween), a molecular mass of from 100 to 10 000 daltons (including all values and subvalues therebetween) (including all values and subvalues therebetween) and in each case one or more reactive (cyclo)aliphatic and/or aromatic hydroxyl group(s) and/or primary and/or secondary amino group(s) and/or mercapto group(s), containing the structural elements arranged intrachemically and/or laterally and/or terminally in the main chain and/or side chain

—(CF₂—CF₂)ₓ—

and/or

—(CR₂—CR₂)ₓ—

and/or

—[CF₂—CF(CF₃)—O]ₓ—

and/or

—(CR₂—CR₂—O)ₓ—
with 95 to 5% by weight (including all values and subvalues therebetween) of an isocyanatoalkylalkoxysilane component (C)(i), consisting of a 3-isocyanatopropyltrialkoxysilane and/or a 3-isocyanatopropylalkoxyalkylsilane and/or isocyanatoalkylalkoxysilanes of the general formula

OCN—(CR²₂)_{y′}—Si(OR¹)_{3-x′}R²_{x′}
where x′=0-2, y′=1-3 and R¹, R²=independently of one another alkyl, cycloalkyl, aryl, any desired organic radical in each case having 1-25 carbon atoms
and/or another isocyanatosilane component (C)(ii) having a molecular mass of from 200 to 2000 daltons (including all values and subvalues therebetween) (including all values and subvalues therebetween) and in each case one or more (cyclo)aliphatic and/or aromatic isocyanato group(s) and one or more alkoxysilane group(s), the reaction preferably being carried out in the molar ratio 1:1 in any desired manner,
   and/or
a_{2.1}) 5 to 95% by weight (including all values and subvalues therebetween) of a (per)fluoroalkyl alcohol component (B)(i) and/or a (per)fluoroalkylalkylenamine component (B)(ii) and/or fluorine-modified macromonomers or telechels (B)(iii) with 75 to 5% by weight (including all values and subvalues therebetween) of a polyisocyanate component (D)(i), consisting of at least one diisocyanate, polyisocyanate, polyisocyanate derivative or polyisocyanate homologue having two or more (cyclo)aliphatic and/or aromatic isocyanate groups of identical or different reactivity, the reaction conditions and the selectivities of components (B) and (D) being chosen such that only one isocyanate group of component (D)(i) reacts with component (B),
a_{2.2}) then further reacting the preadduct from stage a_{2.1}) with 75 to 5% by weight (including all values and subvalues therebetween) of an aminoalkylalkoxysilane component (E)(i), consisting of a 3-aminopropyltrialkoxysilane and/or a (substituted) 3-aminopropylalkoxyalkylsilane of the general formula

R³₂N—(CR₂)_{y′}—Si(OR¹)_{3-x′}R²_{x′}

where x′=0-2, y′=1-6 and R¹, R²=independently of one another alkyl, cycloalkyl, aryl, any desired organic radical having in each case 1-25 carbon atoms, R³=independently of one another alkyl, cycloalkyl, aryl, any desired organic radical having 1-25 carbon atoms, (R¹O)_{3-x′}R²_{x′}Si(CR³₂)_{y′}, R^{3′}₂N—(CR^{3′})_{y′}-[NH—(CR^{3′}₂)_{y′}]_{n′}, where n′=0-10, where R^{3′}=independently of one another alkyl, cycloalkyl, aryl, any desired organic radical having in each case 1-25 carbon atoms
and/or an aminosilane component (E)(ii) different from (E) (i) and having a molecular mass of from 200 to 2000 daltons (including all values and subvalues therebetween) (including all values and subvalues therebetween) and in each case one or more primary and/or secondary and/or tertiary amino group(s) and one or more alkoxysilane group(s), the reaction preferably being carried out in the molar ratio 1:1:1 in any desired manner,
and/or
a₃) reacting 5 to 95% by weight (including all values and subvalues therebetween) of a (per)fluoroalkylalkylene isocyanate component (B)(iv) of the general formula

CF₃—(CF₂)ₓ—(CH₂)_{y}—NCO

or

CR₃—(CR₂)ₓ—(CH₂)_{y}—NCO
having a molecular mass of from 200 to 2000 daltons (including all values and subvalues therebetween) (including all values and subvalues therebetween) and one or more (cyclo)aliphatic and/or aromatic isocyanato group(s) with 95 to 5% by weight (including all values and subvalues therebetween) of an aminosilane component (E)(i) and/or (E)(ii), giving an adduct of the general formula

(B)(iv)-(E)
where (B)(iv)=protonated component (B)(iv) and (E)=deprotonated components (E)(i) and/or (E)(ii)
the reaction preferably being carried out in the molar ratio 1:1 in any desired manner,
and/or
a₄) reacting reaction products having two or more hydroxyl groups from 5 to 95% by weight (including all values and subvalues therebetween) of a (per)fluoroalkylalkanecarboxylic acid (derivative) component (B)(v) of the general formula

CF₃—(CF₂)ₓ—(CH₂)_{y}—COR⁴

or

CR₃—(CR₂)ₓ—(CH₂)_{y}—COR⁴
in which R⁴═F, Cl, Br, I, OH, OMe, OEt
having a molecular mass of from 200 to 2000 daltons (including all values and subvalues therebetween) (including all values and subvalues therebetween) and one or more carboxylic acid (derivative) group(s) with 95 to 5% by weight (including all values and subvalues therebetween) of an aminosilane component (E)(i) and/or (E)(ii), giving, with elimination of HR⁴, an adduct of the general formula

(B)(v)-(E)
(idealized)
where (B)(v)=carbonyl radical of component (B)(v) and (E)=deprotonated components (E)(i) and/or (E)(ii)
and the reaction preferably being carried out in the molar ratio 1:1 in any desired manner,
and/or
a₅) reacting 5 to 95% by weight (including all values and subvalues therebetween) of a hexafluoropropene oxide component (F)(i), consisting of monofunctional hexafluoropropene oxide oligomers of the general formula

CF₃—CF₂—CF₂—O—(CF(CF₃)—CF₂—O)ₙ—CF(CF₃)—COR⁴
in which m=1-20
with 95 to 5% by weight (including all values and subvalues therebetween) of an aminosilane component (E)(i) and/or (E)(ii), giving, with elimination of HR⁴, adducts of the general formula

(F)(i)-(E)
in which (F)(i)=carbonyl radical of component (F)(i)) and (E)=deprotonated components (E)(i) and/or (E)(ii)
and the reaction preferably being carried out in the molar ratio 1:1 in any desired manner,
and/or
a₆) reacting 5 to 95% by weight (including all values and subvalues therebetween) of a hexafluoropropene oxide component (F)(ii), consisting of difunctional hexafluoropropene oxide oligomers of the general formula

R⁴OC—CF(CF₃)—(O—CF₂—CF(CF₃))ₙ—O—(CF₂)ₒ—O—(CF(CF₃)—CF₂—O)ₙ—CF(CF₃)—COR⁴
where n=1-10, o=2-6
with 95 to 5% by weight (including all values and subvalues therebetween) of an aminoalkylalkoxysilane component (E)(i) and/or an (E)(ii), giving, with elimination of HR⁴, adducts of the general formula

(E)-(F)(ii)-(E)
in which (F)(ii)=carbonyl radical of component (F)(i)) and (E)=deprotonated components (E)(i) and/or (E)(ii)
and the reaction preferably being carried out in the molar ratio 1:1 in any desired manner,
and/or
a₇) reacting 5 to 95% by weight (including all values and subvalues therebetween) (including all values and subvalues therebetween) of a (per)fluoroalkyl alcohol component (B)(i) and/or a (per)fluoroalkylalkylenamine component (B)(ii) and/or a fluorine-modified macromonomer or telechel (B)(iii) with 75 to 5% by weight (including all values and subvalues therebetween) of an aminoalkylalkoxysilane component (E)(i) and/or (E)(ii) and 75 to 5% by weight (including all values and subvalues therebetween) of a polyisocyanate component (D)(ii), consisting of a triisocyanate, polyisocyanate, polyisocyanate derivative or polyisocyanate homologue having at least three (cyclo)aliphatic and/or aromatic isocyanate groups of identical or different reactivity, the reaction in the case of trifunctional isocyanates preferably being carried out in the molar ratio 2:1:1 or 1:2:1 in any desired manner,
and/or
a₈) reacting 5 to 75% by weight (including all values and subvalues therebetween) of a (per)fluoroalkyl alcohol component (B)(i) and/or a (per)fluoroalkylalkylenamine component (B)(ii) and/or a fluorine-modified macromonomer or telechel (B)(iii) with 50 to 5% by weight (including all values and subvalues therebetween) of an aminoalkylalkoxysilane component (E)(i) and/or (E)(ii), 50 to 5% by weight (including all values and subvalues therebetween) of a monofunctional polyalkylene glycol component (G)(i) and/or a monofunctional polyoxyalkylenamine component (G)(ii), consisting of monohydroxy-functional alkyl/cycloalkyl/aryl polyethylene glycols and/or alkyl/cycloalkyl/aryl poly(ethylene oxide-block-alkylene oxide) and/or alkyl/cycloalkyl/aryl poly(ethylene oxide-co-alkylene oxide) and/or alkyl/cycloalkyl/aryl poly(ethylene oxide-ran-alkylene oxide) with 25 to 99.9% by weight (including all values and subvalues therebetween) of ethylene oxide and 0 to 75% by weight (including all values and subvalues therebetween) of a further alkylene oxide having 3 to 20 carbon atoms, consisting of propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having 4 to 20 carbon atoms per alkylene oxide or mixtures thereof, of the general formula

R⁵—O-A_{z′}-H
where z′=5-150, R⁵=alkyl, cycloalkyl, aryl, any desired organic radical having 1-25 carbon atoms
and/or
monoamino-functional alkyl/cycloalkyl/aryl polyethylene glycols and/or alkyl/cycloalkyl/aryl poly(ethylene oxide-block-alkylene oxide) and/or alkyl/cycloalkyl/aryl poly(ethylene oxide-co-alkylene oxide) and/or alkyl/cycloalkyl/aryl poly(ethylene oxide-ran-alkylene oxide) with 25 to 99.9% by weight (including all values and subvalues therebetween) of ethylene oxide and 0 to 75% by weight (including all values and subvalues therebetween) of a further alkylene oxide having 3 to 20 carbon atoms, consisting of propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having 4 to 20 carbon atoms per alkylene oxide or mixtures thereof, of the general formula

R⁵—O—(CRⁱRⁱⁱ—CRⁱⁱⁱR^{iv}—O)_{z′-1}—CRⁱRⁱⁱ—CRⁱⁱⁱR^{iv}—NH₂
and 50 to 5% by weight (including all values and subvalues therebetween) of a polyisocyanate component (D)(ii), the reaction in the case of trifunctional isocyanates preferably being carried out in the molar ratio 1:1:1:1 in any desired manner,
and/or
a₉) reacting 5 to 95% by weight (including all values and subvalues therebetween) of a (per)fluoroalkyl alcohol component (B)(i) and/or a (per)fluoroalkylalkylenamine component (B)(ii) and/or a fluorine-modified macromonomer or telechel (B)(iii) with 75 to 5% by weight (including all values and subvalues therebetween) of an aminoalkylalkoxysilane component (E)(i) and/or an (E)(ii) and 75 to 5% by weight (including all values and subvalues therebetween) of a triazine component (H), consisting of cyanuric chloride and/or 2,4,6-trichloro-1,3,5-triazine, the reaction preferably being carried out in the molar ratio 2:1:1 or 1:2:1 in any desired manner,
and/or
a₁₀) reacting 5 to 75% by weight (including all values and subvalues therebetween) of a (per)fluoroalkyl alcohol component (B)(i) and/or a (per)fluoroalkylalkylenamine component (B)(ii) and/or a fluorine-modified macromonomer or telechel (B)(iii) with 50 to 5% by weight (including all values and subvalues therebetween) of an aminoalkylalkoxysilane component (E)(i) and/or (E)(ii), 50 to 5% by weight (including all values and subvalues therebetween) of a monofunctional polyalkylene glycol component (G)(i) and/or a monofunctional polyoxyalkylenamine component (G)(ii) and 50 to 5% by weight (including all values and subvalues therebetween) of a triazine component (H), consisting of cyanuric chloride and/or 2,4,6-trichloro-1,3,5-triazine, the reaction preferably being carried out in the molar ratio 1:1:1:1 in any desired manner,
and/or
a₁₁) reacting 5 to 75% by weight (including all values and subvalues therebetween) of a (per)fluoroalkyl alcohol component (B)(i) and/or a (per)fluoroalkylalkylenamine component (B)(ii) and/or a fluorine-modified macromonomer or telechel (B)(iii) with 50 to 5% by weight (including all values and subvalues therebetween) of an aminoalkylalkoxysilane component (E)(i) and/or (E)(ii), 50 to 5% by weight (including all values and subvalues therebetween) of a polyfunctional polyalkylene glycol component (G)(iii) and/or a polyfunctional polyoxyalkylenamine component (G)(iv), consisting of polyhydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25 to 99.9% by weight (including all values and subvalues therebetween) of ethylene oxide and 0 to 75% by weight (including all values and subvalues therebetween) of a further alkylene oxide having 3 to 20 carbon atoms, consisting of propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having 4 to 20 carbon atoms per alkylene oxide or mixtures thereof, of the general formula

R⁶(—O-A_{z′-H)}_{z″}
where z″=2-6, R⁶=alkyl, cycloalkyl, aryl, any desired organic radical having 1-25 carbon atoms
and/or
polyamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25 to 99.9% by weight (including all values and subvalues therebetween) of ethylene oxide and 0 to 75% by weight (including all values and subvalues therebetween) of a further alkylene oxide having 3 to 20 carbon atoms, consisting of propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having 4 to 20 carbon atoms per alkylene oxide or mixtures thereof, of the general formula

R⁶(—O-A_{z′-1}CRⁱRⁱⁱ—CRⁱⁱⁱR^{iv}—NH₂)_{z″}
and 50 to 5% by weight (including all values and subvalues therebetween) of a polyisocyanate component (D)(i), the reaction in the case of dihydroxy-functional glycols preferably being carried out in the molar ratio 1:1:1:2 in any desired manner,
and/or
a₁₂) 5 to 75% by weight (including all values and subvalues therebetween) of a (per)fluoroalkyl alcohol component (B)(i) and/or a (per)fluoroalkylalkylenamine component (B)(ii) and/or a fluorine-modified macromonomer or telechel (B)(iii) with 50 to 5% by weight (including all values and subvalues therebetween) of an aminoalkylalkoxysilane component (E)(i) and/or (E)(ii), 50 to 5% by weight (including all values and subvalues therebetween) of a hydroxycarboxylic acid component (I), consisting of a monohydroxycarboxylic acid and/or a dihydroxycarboxylic acid having one or two hydroxyl group(s) reactive towards polyisocyanates and a carboxyl group inert towards polyisocyanates, and 50 to 5% by weight (including all values and subvalues therebetween) of a polyisocyanate component (D)(ii), consisting of at least one triisocyanate, polyisocyanate, polyisocyanate derivative or polyisocyanate homologue having at least three (cyclo)aliphatic and/or aromatic isocyanate groups of identical or different reactivity, the reaction in the case of trifunctional isocyanates preferably being carried out in the molar ratio 1:1:1:1 in any desired manner,
and/or
a₁₃) reacting 5 to 75% by weight (including all values and subvalues therebetween) of a (per)fluoroalkyl alcohol component (B)(i) and/or a (per)fluoroalkylalkylenamine component (B)(ii) and/or a fluorine-modified macromonomer or telechel (B)(iii) with 50 to 5% by weight (including all values and subvalues therebetween) of an aminoalkylalkoxysilane component (E)(i) and/or (E)(ii), 50 to 5% by weight (including all values and subvalues therebetween) of an NCN component (J), consisting of cyanamide with an NH-acidic amino group reactive towards polyisocyanates, and 50 to 5% by weight (including all values and subvalues therebetween) of a polyisocyanate component (D)(ii), consisting of at least one triisocyanate, polyisocyanate, polyisocyanate derivative or polyisocyanate homologue having at least three (cyclo)aliphatic and/or aromatic isocyanate groups of identical or different reactivity, the reaction in the case of trifunctional isocyanates preferably being carried out in the molar ratio 1:1:1:1 in any desired manner,
and/or
a₁₄) reacting 5 to 95% by weight (including all values and subvalues therebetween) of a (per)fluoroalkyl alcohol component (B)(i) and/or a (per)fluoroalkylalkylenamine component (B)(ii) and/or a fluorine-modified macromonomer or telechel component (B)(iii), 75 to 5% by weight (including all values and subvalues therebetween) of a carbonyl component (K) of the general formula

X—CO—Y
where X, Y=independently of one another F, Cl, Br, I, CCl₃, R⁷, OR⁷ where R⁷=alkyl, cycloalkyl, aryl, any desired organic radical having 1-25 carbon atoms, 0-10 N atoms and 0-10 O atoms
with 75 to 5% by weight (including all values and subvalues therebetween) of an aminoalkylalkoxysilane component (E)(i) and/or (E)(ii), giving, in the first stage with elimination of HX and/or HY, an adduct of the general formula

(B)—CO—Y and/or X—CO—(B)

or

(E)-CO—Y and/or X—CO-(E)
where (B)=deprotonated components (B)(i) and/or (B)(ii) and/or (B)(iii), (E)=deprotonated components (E)(i) and/or (E)(ii)
and, in the second stage with elimination of HX and/or HY, an adduct of the general formula

(B)—CO-(E)
and the reaction preferably being carried out in the molar ratio 1:1:1 in any desired manner,
or
reacting 5 to 95% by weight (including all values and subvalues therebetween) of a preprepared adduct of the general formula

(B)—CO—Y and/or X—CO—(B)
with 95 to 5% by weight (including all values and subvalues therebetween) of an aminoalkylalkoxysilane component (E)(i) and/or (E)(ii), giving, with elimination of HX and/or HY, an adduct of the general formula

(B)—CO-(E)
and the reaction preferably being carried out in the molar ratio 1:1 in any desired manner,
or
reacting 5 to 95% by weight (including all values and subvalues therebetween) of a preprepared adduct of the general formula

(E)-CO—Y and/or X—CO-(E)
with 95 to 5% by weight (including all values and subvalues therebetween) of (per)fluoroalkyl alcohol component (B)(i) and/or a (per)fluoroalkylalkylenamine component (B)(ii) and/or a fluorine-modified macromonomer or telechel component (B)(iii), giving, with elimination of HX and/or HY, an adduct of the general formula

(B)—CO-(E)
and the reaction preferably being carried out in the molar ratio 1:1 in any desired manner,
and/or
a₁₅) in the case of the reaction products according to a₂) to a₁₄) replacing the aminoalkylalkoxysilane component (E)(i) and/or the aminosilane component (E)(ii) by a mercaptoalkylalkoxysilane component (L)(i) consisting of a 3-mercaptopropyltrialkoxysilane of the general formula

HS—(CR³₂)_{y′}—Si(OR¹)_{3-x′}R²_{x′}
and/or by another mercaptosilane component (L)(ii) of molecular mass from 200 to 2000 daltons (including all values and subvalues therebetween) having one or more mercapto group(s) and one or more alkoxysilane group(s)
and/or
a₁₆) reacting 5 to 95% by weight (including all values and subvalues therebetween) of a (per)fluoroalkylalkylene oxide component (M) of the general formula

CF₃—(CF₂)ₓ—(CH₂)_{y}—CHOCH₂

or

CR₃—(CR₂)ₓ—(CH₂)_{y}—CHOCH₂

or

CR₃—(CR₂)ₓ—(CH₂)_{y}—O—CH₂—CHOCH₂
of molecular mass from 200 to 2000 daltons (including all values and subvalues therebetween) and having one or more epoxy group(s) with 95 to 5% by weight (including all values and subvalues therebetween) of an aminosilane component (E)(i) and/or (E)(ii), the reaction preferably being carried out in the molar ratio 1:1 or 1:2 in any desired manner,
and/or
a₁₇) reacting 5 to 95% by weight (including all values and subvalues therebetween) of a (per)fluoroalkylalkylene oxide component (M), 75 to 5% by weight (including all values and subvalues therebetween) of an epoxyalkylolalkoxysilane component (N)(i) and/or a component (N)(ii) different from (N)(i), consisting of a (substituted) 3-glycidyloxypropyltrialkoxysilane of the general formula

CH₂OCH—CH₂—O—(CR³₂)_{y′}—Si(OR¹)_{3-x′}R²_{x′}
having a molecular mass of from 200 to 2000 daltons (including all values and subvalues therebetween) and one or more epoxy group(s) with 75 to 5% by weight (including all values and subvalues therebetween) of a polyamine component (O) having a molecular mass of from 60 to 5000 daltons (including all values and subvalues therebetween) and one or more (cyclo)aliphatic and/or aromatic primary and/or secondary amino group(s) reactive towards epoxide groups and if desired one or more hydroxyl group(s), the reaction preferably being carried out in the molar ratio 1:1:1 or 2:2:1 in any desired manner,
and/or
a₁₈) reacting 5 to 95% by weight (including all values and subvalues therebetween) of an epoxy-functional polyhedral oligomeric polysilsesquioxane component (POSS) (P)(i) having one or more epoxy groups and one or more perfluoroalkyl groups of the general formula

(R⁸ᵤR⁹ᵥR¹⁰_{w}SiO_{1.5})ₚ
where 0<u<1, 0<v<1, 0<w<1, u+V+W=1, p=4, 6, 8, 10, 12 and R⁸, R⁹, R¹⁰=independently of one another any desired inorganic and/or organic and if desired polymeric radical having 1 to 250 carbon atoms and 0 to 50 N atoms and/or 1 to 50 O atoms and/or 3 to 100 F atoms and/or 0 to 50 Si atoms and/or 0 to 50 S atoms
with 95 to 5% by weight (including all values and subvalues therebetween) of an aminosilane component (E)(i) and/or (E)(ii), the reaction preferably being carried out in the molar ratio 1:(>)1 in any desired manner,
and/or
a₁₉) reacting 5 to 95% by weight (including all values and subvalues therebetween) of an amino-functional polyhedral oligomeric polysilsesquioxane component (POSS) (P)(ii) having one or more amino groups and one or more perfluoroalkyl groups of the general formula

(R⁸ᵤR⁹ᵥR¹⁰_{w}SiO_{1.5})ₚ
with 95 to 5% by weight (including all values and subvalues therebetween) of an isocyanatoalkylalkoxysilane component (C)(i) and/or a component (c)(ii) different from (C)(i), the reaction preferably being carried out in the molar ratio 1:(>)1 in any desired manner,
and/or
a₂₀) reacting 5 to 95% by weight (including all values and subvalues therebetween) of a (meth)acryloyl-functional polyhedral oligomeric polysilsesquioxane component (POSS) (P)(iii) having one or more (meth)acryloyl groups and one or more perfluoroalkyl groups of the general formula

(R⁸ᵤR⁹ᵥR¹⁰_{w}SiO_{1.5})ₚ
with 95 to 5% by weight (including all values and subvalues therebetween) of an amino alcohol component (Q)(i) having one or more (cyclo)aliphatic and/or aromatic primary and/or secondary amino group(s) reactive towards epoxide groups and one or more hydroxyl group(s) having a molar mass of from 60 to 5000 daltons (including all values and subvalues therebetween) (including all values and subvalues therebetween) and/or another amino alcohol component (Q)(ii), the reaction preferably being carried out in the molar ratio 1:(>)1 in any desired manner,
or using preprepared fluorosilanes (A)(ii) such as
a₂₁) (per)fluoroalkylalkoxysilanes of the general formula

CF₃—(CF₂)ₓ—(CH₂)_{y}—Si(OR¹)_{3-x′}R²_{x′}

or

CR₃—(CR₂)ₓ—(CH₂)_{y}—Si(OR¹)_{3-x′}R²_{x′}
and/or
a₂₂) other reaction products containing the structural elements

—(CF₂—CF₂)ₓ—

and/or

—(CR₂—CR₂)ₓ—

and/or

—[CF₂—CF(CF₃)—O]ₓ—

and/or

—(CR₂—CR₂—O)ₓ—

and

—Si(OR¹)_{3-x′}R²_{x′},
0 to 10 parts by weight (including all values and subvalues therebetween) of a catalyst component (R) and 0 to 250 parts by weight (including all values and subvalues therebetween) of a solvent component (S)(i) being present besides 2.5 to 250 parts by weight (including all values and subvalues therebetween) of the pure fluorosilane component (A),
b₁) if desired, partially or completely removing the solvent component (S)(i) from stage a) before, during or after the reaction by distillation,
b₂) if desired, partially or completely removing the catalyst component (R) from stage a) after the reaction through suitable absorption materials or other measures,
b₃) dissolving the mixture from stage a) before, during or after the reaction in 0 to 250 parts by weight (including all values and subvalues therebetween) of a solvent component (S)(ii),
c) a stabilizing component (T), prepared by reacting
   c_{1.1}) 5 to 95% by weight (including all values and subvalues therebetween) of an amino alcohol component (Q)(i) and/or another amino alcohol component (Q)(ii) and 95 to 5% by weight (including all values and subvalues therebetween) of an isocyanatosilane component (C)(i) and/or (C)(ii), the reaction preferably being carried out in the molar ratio 1:1 in any desired manner,
   and/or
   c_{1.2}) 5 to 75% by weight (including all values and subvalues therebetween) of an amino alcohol component (Q)(i) and/or another amino alcohol component (Q)(ii), 75 to 5% by weight (including all values and subvalues therebetween) of an aminosilane component (E)(i) and/or (E)(ii) and 75 to 5% by weight (including all values and subvalues therebetween) of a polyisocyanate component (D)(i), the reaction preferably being carried out in the molar ratio 1:1:1 in any desired manner,
   and/or
   c_{1.3}) 5 to 95% by weight (including all values and subvalues therebetween) of a hydroxycarboxylic acid component (I) and 95 to 5% by weight (including all values and subvalues therebetween) of an isocyanatosilane component (C)(i) and/or (C)(ii), the reaction preferably being carried out in the molar ratio 1:1 in any desired manner,
   and/or
   c_{1.4}) 5 to 75% by weight (including all values and subvalues therebetween) of a hydroxycarboxylic acid component (I), 75 to 5% by weight (including all values and subvalues therebetween) of an aminosilane component (E)(i) and/or (E)(ii) and 75 to 5% by weight (including all values and subvalues therebetween) of a polyisocyanate component (D)(i), the reaction preferably being carried out in the molar ratio 1:1:1 in any desired manner,
   and/or
   c_{1.5}) 5 to 95% by weight (including all values and subvalues therebetween) of an NCN component (J) and 95 to 5% by weight (including all values and subvalues therebetween) of an isocyanatosilane component (C)(i) and/or (c)(ii), the reaction preferably being carried out in the molar ratio 1:1 in any desired manner,
   and/or
   c_{1.6}) 5 to 75% by weight (including all values and subvalues therebetween) of an NCN component (J), 75 to 5% by weight (including all values and subvalues therebetween) of an aminosilane component (E)(i) and/or (E)(ii) and 75 to 5% by weight (including all values and subvalues therebetween) of a polyisocyanate component (D)(i), the reaction preferably being carried out in the molar ratio 1:1:1 in any desired manner,
   and/or
   c_{1.7}) 5 to 95% by weight (including all values and subvalues therebetween) of an aminosilane component (E)(i) and/or (E)(ii) and 95 to 5% by weight (including all values and subvalues therebetween) of an acid component (U)(i), consisting of unsaturated carboxylic acids, the reaction preferably being carried out in the molar ratio 1:>1 in any desired manner,
   and/or
   c_{1.8}) 5 to 95% by weight (including all values and subvalues therebetween) of an aminosilane component (E)(i) and/or (E)(ii) and 95 to 5% by weight (including all values and subvalues therebetween) of an acid component (U)(ii), consisting of unsaturated carboxylic acid anhydrides, the reaction preferably being carried out in the molar ratio 1:>1 in any desired manner,
   and/or
   c_{1.9}) 5 to 95% by weight (including all values and subvalues therebetween) of an aminosilane component (E)(i) and/or (E)(ii) and 95 to 5% by weight (including all values and subvalues therebetween) of an acid component (U)(iii), consisting of γ- and/or δ-lactones of aldonic acids and/or sugar acids and/or polyhydroxy(di)carboxylic acids and/or polyhydroxycarboxaldehydes, the reaction in the case of monolactones preferably being carried out in the molar ratio 1:1 and in the case of dilactones preferably in the molar ratio 2:1 in any desired manner, and giving hydrophilic silanes of the general formula

(E)-CO—[CH(OH)₄]—CH₂OH

and/or

(E)-CO—[CH(OH)₄]—CHO

and/or

(E)-CO—[CH(OH)₄]—CO-(E),
the reaction products according to c_{1.1}) to c_{1.9}) containing 0 to 10 parts by weight (including all values and subvalues therebetween) of a catalyst component (R), 0 to 250 parts by weight (including all values and subvalues therebetween) of a solvent component (S)(i) and 0 to 250 parts by weight (including all values and subvalues therebetween) of a solvent component (S)(ii),
   and a hydrophilic silane component (V) prepared using
   c_{1.10}) a nonionic silane component (E)(iii) of the general formula

R¹¹—O-A_{z′}-(CH₂)_{y′}—Si(OR¹)_{3-x′}R²_{x′}

and/or

HO-A_{z′}-(CH₂)_{y′}—Si(OR¹)_{3-x′}R²_{x′}
in which R¹¹=alkyl, cycloalkyl, aryl, any desired organic radical having in each case 1-25 carbon atoms,
and/or
c_{1.11}) 5 to 95% by weight (including all values and subvalues therebetween) of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv) and 95 to 5% by weight (including all values and subvalues therebetween) of an isocyanatosilane component (C)(i) and/or (C)(ii), the reaction in the case of monohydroxy- or monoamino-functional glycols preferably being carried out in the molar ratio 1:1 in any desired manner,
and/or
c_{1.12}) 5 to 75% by weight (including all values and subvalues therebetween) of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv), 75 to 5% by weight (including all values and subvalues therebetween) of an aminosilane component (E)(i) and/or (E)(ii) and 75 to 5% by weight (including all values and subvalues therebetween) of a polyisocyanate component (D)(i), the reaction in the case of monohydroxy- or monoamino-functional glycols preferably being carried out in the molar ratio 1:1:1 in any desired manner,
and/or
c_{1.13}) 5 to 95% by weight (including all values and subvalues therebetween) of a polyoxyalkylenamine component (G)(ii) and/or a polyfunctional polyoxyalkylenamine component (G)(iv) and 95 to 5% by weight (including all values and subvalues therebetween) of an epoxyalkylolalkoxysilane component (N)(i) and/or an epoxysilane component (N)(ii) different from (N)(i), the reaction in the case of monoamino-functional glycols preferably being carried out in the molar ratio 1:1 or 1:2 in any desired manner,
and/or
c_{1.14}) 5 to 75% by weight (including all values and subvalues therebetween) of a monofunctional polyalkylene glycol component (G)(i) and/or a monofunctional polyoxyalkylenamine component (G)(ii), 50 to 5% by weight (including all values and subvalues therebetween) of an aminosilane component (E)(i) and/or (E)(ii) and 50 to 5% by weight (including all values and subvalues therebetween) of a polyisocyanate component (D)(ii), the reaction in the case of trifunctional isocyanates preferably being carried out in the molar ratio 1:2:1 or 2:1:1 in any desired manner,
and/or
c_{1.15}) 5 to 75% by weight (including all values and subvalues therebetween) of a monofunctional polyalkylene glycol component (G)(i) and/or a monofunctional polyoxyalkylenamine component (G)(ii), 50 to 5% by weight (including all values and subvalues therebetween) of an aminosilane component (E)(i) and/or (E)(ii) and 50 to 5% by weight (including all values and subvalues therebetween) of a triazine component (H), consisting of cyanuric chloride and/or 2,4,6-trichloro-1,3,5-triazine, the reaction preferably being carried out in the molar ratio 1:2:1 or 2:1:1 in any desired manner,
the reaction products according to c_{1.10}) to c_{1.15}) containing 0 to 10 parts by weight (including all values and subvalues therebetween) of a catalyst component (R), 0 to 250 parts by weight (including all values and subvalues therebetween) of a solvent component (S)(i) and 0 to 250 parts by weight (including all values and subvalues therebetween) of a solvent component (S)(ii),
d) reacting the fluorosilane component (A) from stages a) or b), 0.004 to 120 parts by weight (including all values and subvalues therebetween) of the stabilizing component (T) from stage c), 0.004 to 120 parts by weight (including all values and subvalues therebetween) of the hydrophilic silane component (V) from stage c), the solvent components (S)(i) and/or (S)(ii) being partially or completely removed before, during or after the reaction and/or mixing by distillation and, if desired, the catalyst component (R) being partially or completely removed before, during or after the reaction and/or mixing by suitable absorption materials or other measures, such that at most 0 to 1.2 parts by weight (including all values and subvalues therebetween) of a catalyst component (R), 0 to 50 parts by weight (including all values and subvalues therebetween) of a solvent component (S)(i) and 999.892 to 288.8 parts by weight (including all values and subvalues therebetween) of a solvent component (S)(ii) are present, with 950 to 50 parts by weight (including all values and subvalues therebetween) of an activator component (X) containing 0.01 to 10% by weight (including all values and subvalues therebetween) of an acid component (U)(v), 0 to 99.999% by weight (including all values and subvalues therebetween) of a solvent component (S)(ii) and/or 0 to 99.99% by weight (including all values and subvalues therebetween) of water,
e) if desired, 0 to 50 parts by weight (including all values and subvalues therebetween) or 0 to 60 parts by weight (including all values and subvalues therebetween) of a formulation component (Y)(i) being added during or after stages a) and/or b) and/or c) and/or d) in any desired manner and/or 0 to 50 parts by weight (including all values and subvalues therebetween) or 0 to 60 parts by weight (including all values and subvalues therebetween) of a functionalization component (Z), consisting of
   e₁) an aminosilicone oil component (E)(iv) of the general formula

HO—[Si(CH₃)₂—O]_{c}—Si(CH₃)[(CH₂)₃NH(CH₂)₂NH₂]—O—[Si(CH₃)₂—O]_{c}—H

or

R′O—[Si(CH₃)₂—O]_{c}—Si(CH₃)[(CH₂)₃NH(CH₂)₂NH₂]—O—[Si(CH₃)₂—O]_{c}—R′

or

(H₃CO)₂Si[(CH₂)₃NH(CH₂)₂NH₂]-[Si(CH₃)₂—O]_{c}—Si[(CH₂)₃NH(CH₂)₂NH₂](OCH₃)₂
in which c=1-100 and R′═H, Me, Et
and/or
e₂) a low molecular weight silane component (E)(v) of the general formula

R¹²—Si(OR¹)_{3-x′}R²_{x′}
in which R¹²═OR¹, R², independently of one another alkyl, cycloalkyl, aryl, any desired organic radical having 1-25 carbon atoms
and/or
e₃) a hydrophilized aqueous silane component (E)(vi) consisting of (alcohol-free) aminosilane hydrolysates and/or (di/tri)amino/alkyl-functional siloxane-co-oligomers and/or amino/vinyl-functional siloxane-co-oligomers and/or epoxy-functional siloxane-co-oligomers
and/or
e₄) a (reactive) nanoparticle component (Y)(ii), consisting of inorganic and/or organic nanoparticles or nanocomposites in the form of primary particles and/or aggregates and/or agglomerates, it being possible, if desired, for the nanoparticles to be hydrophobicized and/or doped and/or coated and additionally surface-modified with reactive amino groups and/or hydroxyl groups and/or mercapto groups and/or isocyanato groups and/or epoxy groups and/or methacryloyl groups and/or silane groups of the general formula —Si(OR¹)_{3-x′}R²_{x′},
being added and/or co-reacted.

Surprisingly, it has been found that using the liquid fluorine-containing compositions according to the invention, not only are steam-permeable coating or impregnation systems for the permanent oil-, water- and soil-repellent surface treatment or modification of mineral and non-mineral substrates accessible, but that, moreover, these also have significantly better application properties compared to the background art for the same and even lower fluorine content. Through the use of suitable fluorosilane components in combination with suitable stabilizing components and hydrophilic silane components, the critical surface tensions γ_{c} and the contact angle θ of the fluorine-containing compositions according to the invention can be optimized in such a way that, in the respective applications, the hydrophobic, oleophobic and soil-repellent properties come to fruition even at a very low active ingredient concentration or very low fluorine content. In addition, it was not foreseeable that the liquid fluorine-containing compositions according to the invention can also be prepared without solvents or with a low concentration of solvents. Besides (per)fluoroalkyl-functional organosilanes, two-component (per)fluoroalkyl-functional organopolysiloxane precondensates and two-component (per)fluoroalkyl-functional organopolysiloxane condensates are accessible for various fields of application. Upon use of suitable stabilizing components, moreover, (per)fluoroalkyl-functional organopolysiloxane precondensates and (per)fluoroalkyl-functional organopolysiloxane condensates with improved application properties are accessible. Moreover, use of suitable hydrophilic silane components gives (per)fluoroalkyl-functional organopolysiloxane precondensates and (per)fluoroalkyl-functional organopolysiloxane condensates with improved flow behaviour and improved storage stability.

Within the context of the present invention all ranges are to be understood to explicitly include all values and subvalues within the range as well as the outer limits.

Suitable fluorosilane components (A)(i) which can be used are, for example, (per)fluoroalkyl- and/or polyhexafluoropropene oxide-modified and silane-modified reaction products which are prepared by (poly)addition reaction and/or addition/elimination reactions.

Suitable preprepared fluorosilane components (A)(ii) are, for example, the commercial products DYNASILAN® F8161 (tridecafluorooctyltrimethoxysilane), DYNASILAN® F8261 (tridecafluorooctyltriethoxysilane), DYNASILAN® F8263 (fluoroalkylsilane formulation, ready-to-use in isopropanol), DYNASILAN® F8800 (modified fluoroalkylsiloxane, water-soluble), DYNASILAN® F8815 (aqueous, modified fluoroalkylsiloxane) from Degussa GmbH or suitable combination thereof.

Suitable (per)fluoroalkyl alcohol components (B)(i) which can be used are, for example, 3,3,4,4,5,5,6,6,7,7,8,8,8-tridecafluorooctan-1-ol, 3,3,4,4,5,5,6,6,7,7,8,8,9,9,10,10,10-heptadecafluorodecan-1-ol, 3,3,4,4,5,5,6,6,7,7,8,8,9,9,10,10,11,11,12,12,12-heneicosafluorododecan-1-ol, 3,3,4,4,5,5,6,6,7,7,8,8,9,9,10,10,11,11,12,12,13,13,14,14,14-pentacosafluorotetradecan-1-ol, 3,3,4,4,5,5,6,6,7,7,8,8,9,9,10,10,11,11,12,12,13,13,14,14,15,15,16,16,16-nonacosafluorohexadecan-1-ol, 3,3,4,4,5,5,6,6,7,7,8,8-dodecafluoroheptan-1-ol, 3,3,4,4,5,5,6,6,7,7,8,8,9,9,10,10-hexadecafluorononan-1-ol, 3,3,4,4,5,5,6,6,7,7,8,8,9,9,10,10,11,11,12,12-eicosafluoroundecan-1-ol, 3,3,4,4,5,5,6,6,7,7,8,8,9,9,10,10,11,11,12,12,13,13,14,14-tetracosafluorotridecan-1-ol, 3,3,4,4,5,5,6,6,7,7,8,8,9,9,10,10,11,11,12,12,13,13,14,14,15,15,16,16-octacosafluoropentadecan-1-ol, the commercial products FLUOWET® EA 600, FLUOWET® EA 800, FLUOWET® EA 093, FLUOWET® EA 612, FLUOWET® EA 612 N, FLUOWET® EA 812 AC, FLUOWET® EA 812 IW, FLUOWET® EA 812 EP, FLUOWET® EA 6/1020, consisting of perfluoroalkyl ethanol mixtures, FLUOWET® OTL, FLUOWET® OTN, consisting of ethoxylated perfluoroalkyl ethanol mixtures, from Clariant GmbH, the commercial products A-1620, A-1630, A-1660, A-1820, A-1830, A-1860, A-2020, A-3620, A-3820, A-5610, A-5810 from Daikin Industries, Ltd., the commercial products ZONYL® BA, ZONYL® BA L, ZONYL® BA LD, consisting of perfluoroalkyl ethanol mixtures, ZONYL® OTL, ZONYL® OTN, consisting of ethoxylated perfluoroalkylethanol mixtures, ZONYL® FSH, ZONYL® FSO, ZONYL® FSN, ZONYL® FS-300, ZONYL® FSN-100, ZONYL® FSO-100 from Du Pont de Nemours, the commercial products KRYTOX® from Du Pont de Nemours, consisting of hexafluoropropene oxide (HFPO) oligomer/alcohol mixtures, or suitable combinations thereof. Preference is given to using perfluoroalkyl ethanol mixtures with 30-49.9% by weight (including all values and subvalues therebetween) of 3,3,4,4,5,5,6,6,7,7,8,8,8-tridecafluorooctan-1-ol and 30-49.9% by weight (including all values and subvalues therebetween) of 3,3,4,4,5,5,6,6,7,7,8,8,9,9,10,10,10-heptadecafluorodecan-1-ol, such as the commercial products FLUOWET® EA 612 and FLUOWET® EA 812.

Suitable (per)fluoroalkylalkylenamine components (B)(ii) are, for example, 3,3,4,4,5,5,6,6,7,7,8,8,8-tridecafluorooctylamine, 3,3,4,4,5,5,6,6,7,7,8,8,9,9,10,10,10-heptadecafluorodecylamine, 3,3,4,4,5,5,6,6,7,7,8,8,9,9,10,10,11,11,12,12,12-heneicosafluorododecylamine, 3,3,4,4,5,5,6,6,7,7,8,8,9,9,10,10,11,11,12,12,13,13,14,14,14-pentacosafluorotetradecylamine, 3,3,4,4,5,5,6,6,7,7,8,8,9,9,10,10,11,11,12,12,13,13,14,14,15,15,16,16,16-nonacosafluorohexadecylamine, reaction products of 1,1,1,2,2,3,3,4,4,5,5,6,6-tridecafluoro-8-iodoctane, 1,1,1,2,2,3,3,4,4,5,5,6,6,7,7,8,8-heptadecafluoro-10-iododecane, 1,1,1,2,2,3,3,4,4,5,5,6,6,7,7,8,8,9,9,10,10-heneicosafluoro-12-iodododecane, 1,1,1,2,2,3,3,4,4,5,5,6,6,7,7,8,8,9,9,10,10,11,11,12,12-pentacosafluoro-14-iodotetradecane, 1,1,1,2,2,3,3,4,4,5,5,6,6,7,7,8,8,9,9,10,10,11,11,12,12,13,13,14,14-nonacosafluoro-16-iodohexadecane, the commercial products FLUOWET® I 600, FLUOWET® I 800, FLUOWET® I 612, FLUOWET® I 812, FLUOWET® I 6/1020, FLUOWET® I 1020, consisting of perfluoroalkyl iodide mixtures, FLUOWET® EI 600, FLUOWET® EI 800, FLUOWET® EI 812, FLUOWET® EI 6/1020, consisting of perfluoroalkylethyl iodide mixtures, from Clariant GmbH and suitable amination reactions, the commercial products U-1610, U-1710, U-1810 from Daikin Industries Ltd., or suitable combinations thereof. Preference is given to using perfluoroalkylethanol mixtures with 30-49.9% by weight (including all values and subvalues therebetween) of 3,3,4,4,5,5,6,6,7,7,8,8,8-tridecafluorooctylamine and 30-49.9% by weight (including all values and subvalues therebetween) of 3,3,4,4,5,5,6,6,7,7,8,8,9,9,10,10,10-heptadecafluorodecylamine.

Suitable fluorine-modified macromonomers or telechels (B)(iii) which can be used are, for example, 4-(3,3,4,4,5,5,6,6,7,7,8,8,8-tridecafluorooctyl)benzyl alcohol, 4-(3,3,4,4,5,5,6,6,7,7,8,8,9,9,10,10,10-heptadecafluorodecyl)benzyl alcohol, 4-(3,3,4,4,5,5,6,6,7,7,8,8,8-tridecafluorooctylthio)phenol, 4-(3,3,4,4,5,5,6,6,7,7,8,8,9,9,10,10,10-heptadecafluorodecylthio)phenol, 4-(4,4,5,5,6,6,7,7,8,8,9,9,9-tridecafluorononyloxy)benzyl alcohol, 4-(4,4,5,5,6,6,7,7,8,8,9,9,10,10,11,11,11-heptadecafluoroundecyloxy)benzyl alcohol, 4-(3,3,4,4,5,5,6,6,7,7,8,8,8-tridecafluorooctyl)benzylamine, 4-(3,3,4,4,5,5,6,6,7,7,8,8,9,9,10,10,10-heptadecafluorodecyl)benzylamine, 3,3,4,4,5,5,6,6,7,7,8,8,8-tridecafluorooctane-1-thiol,

3,3,4,4,5,5,6,6,7,7,8,8,9,9,10,10,10-heptadecafluorodecane-1-thiol,

3,3,4,4,5,5,6,6,7,7,8,8,9,9,10,10,11,11,12,12,12-heneicosafluorododecane-1-thiol, 3,3,4,4,5,5,6,6,7,7,8,8,9,9,10,10,11,11,12,12,13,13,14,14,14-pentacosafluorotetradecane-1-thiol, 3,3,4,4,5,5,6,6,7,7,8,8,9,9,10,10,11,11,12,12,13,13,14,14,15,15,16,16,16-nonacosafluorohexadecane-1-thiol, hydroxy-functional copolymers based on tetrafluoroethylene and hydroxyalkyl (meth)acrylates, such as the commercial products ZEFFLE® GK-500, GK-510, GK 550 from Daikin Industries Ltd., or suitable combinations thereof.

3,3,4,4,5,5,6,6,7,7,8,8,8-tridecafluoro-1-isocyanatooctane, 3,3,4,4,5,5,6,6,7,7,8,8,9,9,10,10,10-heptadecafluoro-1-isocyanatodecane, 3,3,4,4,5,5,6,6,7,7,8,8,9,9,10,10,11,11,12,12,12-heneicosafluoro-1-isocyanatododecane, 3,3,4,4,5,5,6,6,7,7,8,8,9,9,10,10,11,11,12,12,13,13,14,14,14-pentacosafluoro-1-isocyanatotetradecane, 3,3,4,4,5,5,6,6,7,7,8,8,9,9,10,10,11,11,12,12,13,13,14,14,15,15,16,16,16-nonacosafluoro-1-isocyanatohexadecane or suitable combinations thereof are typical representatives of the (per)fluoroalkylalkylene isocyanate component (B)(iv).

Suitable (per)fluoroalkylalkanecarboxylic acid derivative components (B)(v) are, for example, tridecafluoroheptanoic acid, pentadecafluorooctanoic acid, heptadecafluorononanoic acid, nonadecafluorodecanoic acid, heneicosafluoroundecanoic acid, the commercial products C-1600, C-1700, C-1800, C-1900, C-2000, C-5600, C-5800 from Daikin Industries Ltd., tridecafluoroheptanoyl chloride, pentadecafluorooctanoyl chloride, heptadecafluorononanoyl chloride, nonadecafluorodecanoyl chloride, heneicosafluoroundecanoyl chloride, (m)ethyl tridecafluoroheptanoate, (m)ethyl pentadecafluorooctanoate, (m)ethyl heptadecafluorononanoate, (m)ethyl nonadecafluorodecanoate, (m)ethyl heneicosafluoroundecanoate, the commercial products C-1708, C-5608, C-5808, S-1701, S-1702, S-5602, S-5802 from Daikin Industries Ltd., or suitable combinations thereof.

Suitable isocyanatoalkylalkoxysilane components (C)(i) and/or other isocyanatosilane components (C)(ii) which can be used are, for example, the commercial products SILQUEST® A-1310 silane, SILQUEST® A-LINK™ 25 silane (3-isocyanatopropyl-triethoxysilane), SILQUEST® A-LINK™ 35 silane ((3-isocyanatopropyl)trimethoxysilane), SILQUEST® A-LINK™ 597 silane, SILQUEST® FR-522 silane and SILQUEST® Y-5187 silane from GE Silicones, the commercial products GENIOSIL® GF 40 (3-isocyanatopropyl-trimethoxysilane), GENIOSIL® XL 42 (isocyanatomethylmethyldimethoxysilane) and GENIOSIL® XL 43 (isocyanatomethyltrimethoxysilane) from Wacker-Chemie GmbH or suitable combinations thereof. Within the context of the present invention, 3-isocyanato-propyltrimethoxysilane and/or 3-isocyanatopropyltriethoxysilane are to be regarded as preferred.

Suitable polyisocyanate components (D)(i) and/or other polyisocyanate components (D)(ii) are, for example, polyisocyanates, polyisocyanate derivatives or polyisocyanate homologues having two or more aliphatic or aromatic isocyanate groups of identical or different reactivity or suitable combinations thereof, and here in particular also the polyisocyanates sufficiently known in polyurethane chemistry, or combinations thereof. Suitable aliphatic polyisocyanates are, for example, 1,6-diisocyanatohexane (HDI), 1-isocyanato-5-isocyanatomethyl-3,3,5-trimethylcyclohexane or isophorone diisocyanate (IPDI, commercial product VESTANAT® IPDI from Degussa GmbH), bis(4-isocyanato-cyclohexyl)methane (H₁₂MDI, commercial product VESTANAT® H12MDI from Degussa GmbH), 1,3-bis(1-isocyanato-1-methylethyl)benzene (m-TMXDI), 2,2,4-trimethyl-1,6-diisocyanatohexane or 2,4,4-trimethyl-1,6-diisocyanatohexane (TMDI, commercial product VESTANAT® TMDI from Degussa GmbH), diisocyanates based on dimer fatty acid (commercial product DDI® 1410 diisocyanate from Cognis Deutschland GmbH & Co. KG) or technical-grade isomer mixtures of the individual aliphatic polyisocyanates. Suitable aromatic polyisocyanates which can be used, are, for example, 2,4-diisocyanatotoluene or toluene diisocyanate (TDI), bis(4-isocyanatophenyl)methane (MDI) and its higher homologues (polymeric MDI) or technical-grade isomer mixtures of the individual aromatic polyisocyanates. Furthermore, the so-called “paint polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) are also suitable in principle. The term “paint polyisocyanates” denotes derivatives of these diisocyanates having allophanate, biuret, carbodiimide, iminooxadiazinedione, isocyanurate, oxadiazinetrione, uretdione, urethane groups in which the residual content of monomeric diisocyanates according to the background art has been reduced to a minimum. In addition, it also possible to use modified polyisocyanates which are accessible, for example, through a hydrophilic modification of bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) with monohydroxy-functional polyethylene glycols or aminosulphonic acid sodium salts. Suitable “paint polyisocyanates” which can be used are, for example, the commercial products VESTANAT® T 1890 E, VESTANAT® T 1890 L, VESTANAT® T 1890 M, VESTANAT® T 1890 SV, VESTANAT® T 1890/100 (polyisocyanates based on IPDI trimer), VESTANAT® HB 2640 MX, VESTANAT® HB 2640/100, VESTANAT® HB 2640/LV (polyisocyanates based on HDI biuret), VESTANAT® HT 2500 L, VESTANAT® HB 2500/100, VESTANAT® HB 2500/LV (polyisocyanates based on HDI isocyanurate) from Degussa GmbH, the commercial product BASONAT® HW 100 from BASF AG, the commercial products BAYHYDUR® 3100, BAYHYDUR® VP LS 2150 BA, BAYHYDUR® VP LS 2306, BAYHYDUR® VP LS 2319, BAYHYDUR® VP LS 2336, BAYHYDUR® XP 2451, BAYHYDUR® XP 2487, BAYHYDUR® XP 2487/1, BAYHYDUR® XP 2547, BAYHYDUR® XP 2570, DESMODUR® XP 2565 from Bayer AG, but also the commercial products RHODOCOAT® X EZ-M 501, RHODOCOAT® X EZ-M 502, RHODOCOAT® WT 2102 from Rhodia. According to the invention, the components (D)(i) used are preferably isophorone diisocyanate and/or toluene diisocyanate, and the components (D)(ii) used are preferably an (if desired hydrophilically modified) trimer of 1,6-diisocyanatohexane. The reaction products a₇), a₈), a₁₁), a₁₂), c₁₂) and c_{1.14}) used may also be hydrophilically modified polyisocyanates; when using polyisocyanates modified with monohydroxy-functional polyethylene glycols it is possible to dispense with the use of the monofunctional polyalkylene glycol component (G)(i) and/or of the monofunctional polyoxyalkylenamine component (G)(ii) in the case of the reaction products a₈) and c_{1.14}).

Suitable aminoalkylalkoxysilane components (E)(i) and/or other aminosilane components (E)(ii) are considered to be, for example, the commercial products DYNASILAN® AMMO (3-aminopropyltrimethoxysilane), DYNASILAN® AMEO (AMEO-P) (3-aminopropyltriethoxysilane), DYNASILAN® AMEO-T (proprietary aminosilane combination), DYNASILAN® DAMO (DAMO-P) (N-(2-aminoethyl)-3-aminopropyl-trimethoxysilane), DYNASILAN® DAMO-T (proprietary aminosilane combination), DYNASILAN® TRIAMO (N—[N′-(2-aminoethyl)-2-aminoethyl]-3-aminopropyl-trimethoxysilane), DYNASILAN® 1122 (bis-(3-triethoxysilylpropyl)amine), DYNASILAN™ 1126 (proprietary aminosilane combination), DYNASILAN® 1146 (diamino/alkyl-functional siloxane cooligomer), DYNASILAN® 1189 (N-butyl-3-aminopropyltrimethoxysilane), DYNASILAN® 1204 (proprietary aminosilane combination), DYNASILAN® 1411 (N-(2-aminoethyl)-3-aminopropylmethyldimethoxysilane), DYNASILAN® 1505 (3-amino-propylmethyldiethoxysilane), DYNASILAN® 1506 (3-aminopropylmethyldiethoxysilane preparation in solvent), DYNASILAN® 2201 (3-ureidopropyltriethoxysilane, 50% in methanol) from Degussa GmbH, the commercial products SILQUEST® A-1100 silane, SILQUEST® A-1101 silane, SILQUEST® A-1102 silane, SILQUEST® A-1106 silane, SILQUEST® A-1110 silane, SILQUEST® A-1120 silane, SILQUEST® A-1130 silane, SILQUEST® A-1160 silane, SILQUEST® A-1170 silane, SILQUEST® A-1637 silane, SILQUEST® A-2120 silane, SILQUEST® A-2639 silane, SILQUEST® A-LINK™ 15 silane, SILQUEST® Y-9669 silane from GE Silicones and the commercial products GENIOSIL® GF 9 (N-2-aminoethyl-3-aminopropyltrimethoxysilane), GENIOSIL® GF 91 (N-2-aminoethyl-3-aminopropyltrimethoxysilane), GENIOSIL® GF 93 (3-aminopropyltriethoxysilane), GENIOSIL® GF 95 (N-2-aminoethyl-3-aminopropylmethyldimethoxysilane), GENIOSIL® GF 96 (3-aminopropyltrimethoxysilane), GENIOSIL® XL 924 (N-cyclohexylaminomethylmethyldiethoxysilane), GENIOSIL® XL 926 (N-cyclohexylaminomethyltriethoxysilane), GENIOSIL® XL 972 (N-phenylaminomethylmethyldimethoxysilane), GENIOSIL® XL 973 (N-phenylaminomethyltrimethoxysilane) from Wacker Chemie GmbH or suitable combinations thereof. As preferred components (E)(i), the present invention envisages 3-aminopropyl-trimethoxysilane and/or 3-aminopropyltriethoxysilane and/or N-(2-aminoethyl)-3-aminopropyltrimethoxysilane and/or N-(2-aminoethyl)-3-aminopropyltriethoxysilane and/or N—[N′-(2-aminoethyl)-2-aminoethyl]-3-aminopropyltrimethoxysilane.

Suitable nonionic silane components (E)(iii) which can be used are, for example, the commercial products DYNASILAN® 4140 (4140-A) (trimethoxysilylpropylmethyl-polyethylene glycol), DYNASILAN® 1211 (polyglycol ether-modified aminosilane) from Degussa GmbH, the commercial product SILQUEST® A-1230 silane (trimethoxysilylpropylmethylpolyethylene glycol) from GE Silicones or suitable combinations thereof, particularly suitable components E(iii) being silanes of the general formula

H₃C—O—(CH₂CH₂—O)_{z},—(CH₂)₃—Si(OR¹)₃,

in which z′=5-15 and R¹=Me, Et.

Suitable aminosilicone oil components (E)(iv) which can be used are, for example, the commercial products AO 201, AO 202, AO 1000, AO 1001, AO 1002, AO 4000, AO 4001, AO 4500, AO 6500, comprising aminosilicone oils or hydroxy- and/or alkoxy-terminated poly[3-((2-aminoethyl)amino)propyl]methyl(dimethyl)siloxane, from Nitrochemie Aschau GmbH or suitable combinations thereof.

The commercial products DYNASILAN® MTMS (methyltrimethoxysilane), DYNASILAN® MTES (methyltriethoxysilane), DYNASILAN® PTMO (propyltrimethoxysilane), DYNASILAN® PTEO (propyltriethoxysilane), DYNASILAN® IBTMO (isobutyltrimethoxysilane), DYNASILAN® IBTEO (isobutyltriethoxysilane), DYNASILAN® OCTMO (octyltrimethoxysilane), DYNASILAN® OCTEO (octyltriethoxysilane), DYNASILANX® 9116 (hexadecyltrimethoxysilane), DYNASILAN® 9165 (phenyltrimethoxysilane, formally CP 0330), DYNASILAN® 9265 (phenyltriethoxysilane, formally CP 0320), DYNASILAN® A (tetraethyl orthosilicate) DYNASILAN® A SQ (tetraethyl orthosilicate, high purity), DYNASILAN® M (tetramethyl orthosilicate), DYNASILAN® P (tetra-n-propylsilcate), DYNASILAN® BG (tetrabutyl glycol silicate) DYNASILAN® 40 (ethyl polysilicate) from Degussa GmbH or suitable combinations thereof are suitable low molecular weight silane components (E)(v).

Particularly suitable hydrophilized aqueous silane components (E)(vi) are, for example, the commercial products DYNASILAN® 1161 (cationic, benzylamino-functional silane, hydrochloride, 50% by weight (including all values and subvalues therebetween) in methanol), DYNASILAN® 1172 (cationic, benzylamino-functional silane, hydroacetate, 50% by weight (including all values and subvalues therebetween) in methanol), DYNASILAN® 1151 (aminosilane hydrolysate, alcohol-free), DYNASILAN® HS 2627 (HYDROSIL® 2627) (amino/alkyl-functional siloxane cooligomer, alcohol-free), DYNASILAN® HS 2775 (HYDROSIL® 2775) (triamino/alkyl-functional siloxane cooligomer, alcohol-free), DYNASILAN® HS 2776 (HYDROSIL® 2776, alcohol-free) (diamino/alkyl-functional siloxane cooligomer), DYNASILAN® HS 2781 (HYDROSIL® 2781) (amino/vinyl-functional siloxane cooligomer, alcohol-free), DYNASILAN® HS 2907 (HYDROSIL® 2907) (amino/vinyl-functional siloxane cooligomer, alcohol-free), DYNASILAN® HS 2909 (HYDROSIL® 2909) (amino/alkyl-functional siloxane cooligomer, alcohol-free), DYNASILAN® HS 2926 (HYDROSIL® 2926) (epoxy-functional siloxane cooligomer, alcohol-free) from Degussa GmbH or suitable combinations thereof.

Suitable representatives of the monofunctional hexafluoropropene oxide component (F)(i) are, for example, monofunctional polyhexafluoropropene oxide carboxylic acids, polyhexafluoropropene oxide carbonyl fluorides, polyhexafluoropropene oxide carboxylic acid methyl esters from Dyneon GmbH & Co. KG or suitable combinations thereof.

Suitable difunctional hexafluoropropene oxide components (F)(ii) which can be used are, for example, difunctional polyhexafluoropropene oxide carboxylic acids, polyhexafluoropropene oxide carbonyl fluorides, polyhexafluoropropene oxide carboxylic acid methyl esters from Dyneon GmbH & Co. KG or suitable combinations thereof.

The commercial products M 250, M 350, M 350 PU, M 500, M 500 PU, M 750, M 1100, M 2000 S, M 2000 FL, M 5000 S, M 5000 FL, comprising monofunctional methyl polyethylene glycol, B11/50, B11/70, B11/100, B11/150, B11/150 K, B11/300, B11/700, comprising monofunctional butyl poly(ethylene oxide-ran-propylene oxide), from Clariant GmbH and the commercial product LA-B 729, comprising monfunctional methyl poly(ethylene oxide-block/co-propylene oxide) from Degussa GmbH or suitable combinations thereof are suitable monofunctional polyalkylene glycol components (G)(i).

Suitable monofunctional polyoxyalkylenamine components (G)(ii) are, for example, the commercial products JEFFAMINE® XTJ-505 (M-600), JEFFAMINE® XTJ-506 (M-1000), JEFFAMINE® XTJ-507 (M-2005), JEFFAMINE® M-2070, comprising monofunctional polyoxyalkylenamine based on ethylene oxide and propylene oxide, from Huntsman Corporation or suitable combinations thereof.

Typical representatives of the polyfunctional polyalkylene glycol component (G)(iii) are, for example, the commercial products 200, 200 G, 300, 300 G, 400, 400 G, 600, 600 A, 600 PU, 900, 1000, 1000 WA, 1500 S, 1500 FL, 1500 PS, 2000 S, 2000 FL, 3000 S, 3000 P, 3000 FL, 3350 S, 3350 P, 3350 FL, 3350 PS, 3350 PT, 4000 S, 4000 P, 4000 FL, 4000 PS, 4000 PF, 5000 FL, 6000 S, 6000 P, 6000 PS, 6000 FL, 6000 PF, 8000 S, 8000 P, 8000 FL, 8000 PF, 10000 S, 10000 P, 12000 S, 12000 P, 20000 S, 20000 P, 20000 SR, 20000 SRU, 35000 S, comprising difunctional polyethylene glycol, PR 300, PR 450, PR 600, PR 1000, PR 1000 PU, VPO 1962, comprising difunctional poly(ethylene oxide-block-propylene oxide-block-ethylene oxide), D21/150, D21/300, D21/700, comprising difunctional poly(ethylene oxide-ran-propylene oxide), and P41 /200 K, P41/300, P41/3000, P41 /120000, comprising tetrafunctional poly(ethylene oxide-ran-propylene oxide), from Clariant or suitable combinations thereof.

Polyfunctional polyoxyalkylenamine components (G)(iv) which can be used, are, for example, the commercial products JEFFAMINE® HK-511 (XTJ-511); JEFFAMINE® XTJ-500 (ED-600), JEFFAMINE® XTJ-502 (ED-2003), comprising difunctional polyoxyalkylenamine based on ethylene oxide and propylene oxide, from the Huntsman Corporation or suitable combinations thereof.

Cyanuric chloride and 2,4,6-trichloro-1,3,5-triazine from Degussa GmbH are suitable triazine components (H).

Suitable hydroxycarboxylic acid components (I) are, for example, 2-hydroxymethyl-3-hydroxypropanoic acid or dimethylolacetic acid, 2-hydroxymethyl-2-methyl-3-hydroxypropanoic acid or dimethylolpropionic acid, 2-hydroxymethyl-2-ethyl-3-hydroxypropanoic acid or dimethylolbutyric acid, 2-hydroxymethyl-2-propyl-3-hydroxypropanoic acid or dimethylolvaleric acid, hydroxypivalic acid (HPA), citric acid, tartaric acid or suitable combinations thereof. According to the invention, citric acid and/or hydroxypivalic acid and/or dimethylolpropionic acid are preferably used. If necessary, it is also possible to use amino- and if desired hydrofunctional carboxylic acids, such as 2-hydroxyethanoic acid or amino- and/or hydrofunctional sulphonic acids such as 2-aminoethanoic acid, tris(hydroxymethyl)methyl]-3-aminopropanesulphonic acid.

The NCN component (J) used can, for example, be cyanamide from Degussa GmbH.

As regards carbonyl component (K), phosgene, diphosgene, triphosgene, aliphatic and/or aromatic chloroformates, such as methyl chloroformate, ethyl chloroformate, isopropyl chloroformate, phenyl chloroformate, aliphatic and/or aromatic carbonic acid esters, such as dimethyl carbonate, diethyl carbonate, diisopropyl carbonate, diphenyl carbonate or suitable combination thereof, for example, are to be regarded as suitable. Within the context of this invention, phosgene and/or ethyl chloroformate and/or diethyl carbonate are preferably used. Suitable carbonyl components (A₈) which can be used are furthermore, for example, preprepared adducts of component (K) and components (B)(i) and/or (B)(ii) and/or (B)(iii) or preprepared adducts of component (K) and components (E)(i) and/or (E)(ii), such as the commercial product GENIOSIL® XL 63 (N-(trimethoxysilylmethyl)-O-methyl carbamate from Wacker-Chemie GmbH, N-(triethoxysilylmethyl)-O-methyl carbamate, N-(trimethoxysilylmethyl)-O-ethyl carbamate, N-(triethoxysilylmethyl)-O-ethyl carbamate, N-(trimethoxysilylpropyl)-O-methyl carbamate, N-(triethoxysilylpropyl)-O-methyl carbamate, N-(trimethoxysilylpropyl)-O-ethyl carbamate, N-(triethoxysilylpropyl)-O-ethyl carbamate or suitable combination thereof. Preference is given to using chloroformates or phosgene derivatives of components (B)(i) and/or (B)(ii) and/or (B)(iii) and/or carbamates of components (E)(i) and/or (E)(ii).

Suitable mercaptoalkylalkoxysilane components (L)(i) and/or other mercaptosilane components (L)(ii) are, for example, the commercial products DYNASILAN® MTMO (3-mercaptopropyltrimethoxysilane), DYNASILAN® MTEO (3-mercaptopropyl-triethoxysilane) from Degussa GmbH or suitable combination thereof. Preference is given to using 3-mercaptopropyltrimethoxysilane and/or 3-mercaptopropyltriethoxysilane.

Suitable (per)fluoroalkylalkylene oxide components (M) which can be used are, for example 4, 4,5,5,6,6,7,7,8,8,9,9,9-tridecafluorononene 1,2-oxide, 4,4,5,5,6,6,7,7,8,8,9,9,10,10,11,11,11-heptadecafluoroundecene 1,2-oxide,

4,4,5,5,6,6,7,7,8,8,9,9,10,10,11,11,12,12,13,13,13-heneicosafluorotridecene 1,2-oxide, glycidyl 2,2,3,3,4,4,5,5,6,6,7,7-dodecafluoroheptyl ether, glycidyl 2,2,3,3,4,4,5,5,6,6,7,7,8,8,9,9-hexadecafluorononyl ether, glycidyl 2,2,3,3,4,4,5,5,6,6,7,7,8,8,9,9,10,10,11,11-eicosafluoroundecyl ether, the commercial products E-1830, E-2030, E-3630, E-3830, E-5644, E-5844 from Daikin Industries Ltd. or suitable combination thereof. 4,4,5,5,6,6,7,7,8,8,9,9,9-Tridecafluorononene 1,2-oxide and/or 4,4,5,5,6,6,7,7,8,8,9,9,10,10,11,11,11-heptadecafluoroundecene 1,2-oxide are to be regarded as particularly preferred.

Suitable epoxyalkylolalkoxysilane components (N)(i) and/or other epoxysilane components (N)(ii) are, for example, the commercial products DYNASILAN® GLYMO ((3-glycidyloxypropyl)trimethoxysilane), DYNASILAN® GLYEO ((3-glycidyloxypropyl)-triethoxysilane) from Degussa GmbH, the commercial products COATOSIL® 1770, SILQUEST® A-187 SILANE, SILQUEST® A-186 SILANE, SILQUEST® WETLINK 78 SILANE from GE Silicones, the commercial products GENIOSIL® GF 80 ((3-glycidyloxypropyl)trimethoxysilane), GENIOSIL® GF 82 ((3-glycidyloxypropyl)triethoxysilane) from Wacker-Chemie GmbH or suitable combinations thereof, particular preference being given to 3-glycidyloxypropyltrimethoxysilane and/or 3-glycidyloxypropyltriethoxysilane.

Suitable polyamine components (O) are, for example, adipic dihydrazide, ethylenediamine, diethylenetriamine, triethylenetetramine, tetraethylenepentamine, pentaethylenehexamine, dipropylenetriamine, hexamethylenediamine, hydrazine (hydrate), isophoronediamine, N-(2-aminoethyl)-2-aminoethanol, N,N′-bis(2-hydroxy-ethyl)ethylenediamine or suitable combinations thereof, ethylenediamine being regarded as preferred.

Suitable polyhedral oligomeric polysilsesquioxane components (P)(i) and/or (P)(ii) and/or (P)(iii) which can be used are, for example, polysilsesquioxanes with one or more amino and/or hydroxyl and/or isocyanato and/or mercapto groups and one or more perfluoroalkyl groups of the general formula

(R⁸ᵤR⁹ᵥR¹⁰_{w}SiO_{1.5})₈

in which 0<u<1, 0<v<1, 0<w<1, u+v+w=1,

R⁸, R⁹, R¹⁰=independently of one another any desired inorganic and/or organic and if desired, polymeric radical having 1 to 250 carbon atoms and 0 to 50 N atoms and/or 1 to 50 O atoms and/or 3 to 100 F atoms and/or 0 to 50 Si atoms and/or 0 to 50 S atoms,

and the commercial products CREASIL® from Degussa GmbH and the commercial products POSS® from Hybrid Plastrics, Inc. or suitable combinations thereof.

Within the context of the present invention, suitable amino alcohol components (Q)(i) and/or other amino alcohol components (Q)(ii) are, for example, ethanolamine, N-methylethanolamine, diethanolamine, diisopropanolamine, 3-((2-hydroxyethyl)amino)-1-propanol, trimethylolmethylamine, amino sugars such as galactosamine, glucamine, glucosamine, neuramic acid or suitable combinations, diethanolamine and/or diisopropanolamine and/or trimethylolmethylamine and/or amino sugars being particularly preferred compounds.

Suitable catalyst components (R) are, for example, dibutyltin oxide, dibutyltin dilaurate (DBTL), triethylamine, tin(II) octoate, 1,4-diazabicyclo[2.2.2]octane (DABCO), 1,4-diazabicyclo[3.2.0]-5-nonene (DBN), 1,5-diazabicyclo[5,4,0]-7-undecene (DBU), morpholine derivatives, such as, for example, JEFFCAT® Amine Catalysts or suitable combinations thereof.

As regards the solvent component (S)(i), the present invention proposes low-boiling solvents, such as acetone, butanone, or high-boiling solvents, such as N-methyl-2-pyrrolidone, N-ethyl-2-pyrrolidone, dipropylene glycol dimethyl ether (PROGLYDE DMM®) or suitable combinations thereof. The solvent component (S)(i) is inert towards isocyanate groups.

The solvent components (S)(ii) used, are, for example, low-boiling solvents and preferably ethanol, methanol, 2-propanol or suitable combinations thereof.

Suitable stabilizing components (T) are, for example, anionically and/or cationically and/or nonionically hydrophilically modified and silane-modified reaction products which are usually prepared by a (poly)addition reaction and/or addition/elimination reactions.

Suitable acid components (U)(i) are, in particular, acrylic acid, methacrylic acid, maleic acid, fumaric acid, itaconic acid, 2-acrylamido-2-methylpropane-1-sulphonic acid (AMPS®) or suitable combinations thereof, acrylic acid being regarded as preferred.

Suitable acid components (U)(ii) which can be used, are, for example, acrylic anhydride, methacrylic anhydride, maleic anhydride, itaconic anhydride or suitable combinations thereof, with maleic anhydride as preferred representative.

Suitable acid components (U)(iii) are γ- and/or δ-lactones of sugar acids or polyhydroxy(di)carboxylic acids or polyhydroxycarboxaldehydes, such as D-glucono-δ-lactone, D-glucurono-δ-lactone, ascorbic acid, aldono-γ/δ-lactones, urono-γ/δ-lactones, D-glucaro-γ/δ-lactones or suitable combinations, preference being given to D-glucono-δ-lactone.

Hydrochloric acid is used as typical acid component (U)(v). However, other mono- or polybasic organic acids such as formic acid, acetic acid, oxalic acid, malonic acid, citric acid, mono- or polybasic inorganic acids such as amidosulphonic acid, sulphuric acid, phosphoric acid or suitable combinations thereof are also suitable.

Polyalkylene glycol-modified and silane-modified reaction products which are prepared by (poly)addition reaction and/or addition/elimination reactions are suitable hydrophilic silane components (V).

Suitable activator components (X) are, for example, water- and solvent-containing acids.

Numerous representatives are suitable as formulation component (Y)(i). Of suitability according to the invention are (functionalized) inorganic and/or organic fillers and/or light-weight fillers, (functionalized) inorganic and/or organic pigments, (functionalized) inorganic and/or organic carrier materials, inorganic and/or organic fibres, graphite, carbon black, carbon fibres, carbon nanotubes, metal fibres and metal powders, conductive organic polymers, further polymers and/or redispersible polymer powders, superabsorbents, further inorganic and/or organic compounds, antifoams, deaerators, lubricant and flow additives, substrate wetting additives, wetting and dispersion additives, hydrophobicizing agents, rheology additives, coalescence auxiliaries, matting agents, adhesion promoters, antifreezes, antioxidants, UV stabilizers, biocides, water, solvents, catalysts or suitable combinations thereof.

The (reactive) nanoparticle component (Y)(ii) according to the invention is represented, for example, by fumed silica (SiO₂) such as AEROSIL® fumed silicas doped with rare earths (RE) such as AEROSIL® fumed silicas/RE doped, silver-doped fumed silicas such as AEROSIL® fumed silicas/Ag doped, silicon dioxide/aluminium oxide mixture (mullite) such as AEROSIL® fumed silicas+Al₂O₃, silicon dioxide/titanium dioxide mixture such as AEROSIL® fumed silicas+TiO₂, aluminium oxide (Al₂O₃) such as AEROXIDE® AluC, titanium dioxide (TiO₂) such as AEROXIDE® TiO₂ P25, zirconium dioxide (ZrO₂) VP zirconium oxide PH, yttrium-stabilized zirconium dioxide such as VP zirconium oxide 3YSZ, cerium dioxide (CeO₂) such as ADNANO® CERIA, indium tin oxide (ITO, In₂O₃/SnO₂) such as ADNANO® ITO, nanoscale iron oxide (Fe₂O₃) in a matrix of fumed silica such as ADNANO® MAGSILICA, zinc oxide (ZnO) such as ADNANO® ZINC OXIDE from Degussa GmbH. Preference is given to using silicon dioxide and/or titanium dioxide and/or zinc oxide.

Nanoparticle dispersions can be prepared by introducing nanoparticles into water or into dispersion (e.g. into polymer dispersions) by means of suitable dispersion devices and a high input of energy. Of suitability here are primarily dispersion devices which effect a high input of energy, such as dissolvers, planetary kneaders, rotor-stator machines, ultrasound devices or high-pressure homogenizers; by way of example, the NANOMIZER® or ULTIMIZER® system are mentioned.

At least 50% by weight (including all values and subvalues therebetween) of the total (reactive) nanoparticle component (Y)(ii) have a particle size of at most 500 nm (standard: DIN 53206-1, Testing of pigments; particle size analysis, basic terms) and the totality of the particles which have this particle size of at most 500 nm have a specific surface area (standard: DIN 66131, Determination of the specific surface area of solids by gas adsorption according to Brunauer, Emmet and Teller (BET)) of from 10 to 200 m²/g.

It is likewise envisaged that at least 70% by weight (including all values and subvalues therebetween) and preferably at least 90% by weight (including all values and subvalues therebetween) of the total (reactive) nanoparticle component (Y)(ii) have a particle size of from 10 to 300 nm (standard: DIN 53206-1, Testing of pigments, particle size analysis, basic terms), the totality of the particles which have this particle size of from 10 to 300 nm should, according to the invention, have a specific surface area (standard: DIN 66131, Determination of the specific surface area of solids by gas adsorption according to Brunauer, Emmet and Teller (BET)) of from 30 to 100 m²/g.

According to the present invention, the formulation component (Y)(i) and the (reactive) nanoparticle component (Y)(ii) can be present in coated and/or microencapsulated and/or supported and/or hydrophilized and/or solvent-containing form and if desired be released slowly.

Suitable functionalization components (Z) which can be used are, for example, functionalized silanes and/or siloxanes and nanoparticles.

The present invention further provides a process for the preparation of the fluorine-containing compositions according to the invention. In this process

a) a fluorosilane component (A)(i) is prepared by reacting the components

a₁) (B)(i), (B)(ii), (B)(iii) and (C) and/or

a₂) (B)(i), (B)(ii), (B)(iii), (D)(i), (E)(i) and (E)(ii) and/or

a₃) (B)(iv), (E)(i) and (E)(ii) and/or

a₄) (B)(v), (E)(i) and (E)(ii) and/or

a₅) (F)(i), (E)(i) and (E)(ii) and/or

a₆) (F)(ii), (E)(i) and (E)(ii) and/or

a₇) (B)(i), (B)(ii), (B)(iii), (E)(i), (E)(ii) and (D)(ii) and/or

a₈) (B)(i), (B)(ii), (B)(iii), (E)(i), (E)(ii), (G)(i), (G)(ii) and (H) and/or

a₉) (B)(i), (B)(ii), (B)(iii), (E)(i), (E)(ii) and (H) and/or

a₁₀) (B)(i), (B)(ii), (B)(iii), (E)(i), (E)(ii), (G)(i), (G)(ii) and (H) and/or

a₁₁) (B)(i), (B)(ii), (B)(iii), (E)(i), (E)(ii), (G)(iii), (G)(iv) and (D)(i) and/or

a₁₂) (B)(i), (B)(ii), (B)(iii), (E)(i), (E)(ii), (I) and (D)(ii) and/or

a₁₃) (B)(i), (B)(ii), (B)(iii), (E)(i), (E)(ii), (J) and (D)(ii) and/or

a₁₄) (B)(i), (B)(ii), (B)(iii), (E)(i), (E)(ii) and (K) and/or

a₁₅) according to a₂) to a₁₄), components (E)(i) and E(ii) being replaced by the components (L)(i) and (L)(ii) and/or

a₁₆) (M), (E)(i) and (E)(ii) and/or

a₁₇) (M), (N)(i), (N)(ii) and (O) and/or

a₁₈) (P)(i), (E)(i) and (E)(ii) and/or

a₁₉) (P)(ii), (C)(i) and (C)(ii) and/or

a₂₀) (P)(iii), (Q)(i) and (Q)(ii)

or alternatively fluorosilanes (A)(ii) preprepared according to a₂₁) to a₂₂) are used,

if desired a catalyst component (R) and if desired a solvent component (S)(i) being present besides the pure fluorosilane component (A), then

b₁) if desired the solvent component (S)(i) is partially or completely removed from stage a) before, during or after the reaction by distillation,

b₂) if desired the catalyst component (R) is partially or completely removed from stage a) after the reaction by suitable absorption materials or other measures,

b₃) if desired the fluorosilane component (A) from stage a) is dissolved before, during or after the reaction in the solvent component (S)(ii),

or

c₁) a stabilizing component (T) is prepared by reacting the components

c_{1.1}) (Q)(i), (Q)(ii), (C)(i) and (C)(ii) and/or

c_{1.2}) (Q)(i) (Q)(ii), (E)(i), (E)(ii) and (D)(i) and/or

c_{1.3}) (I), (C)(i) and (C)(ii) and/or

c_{1.4}) (I), (E)(i), (E)(ii) and (D)(i) and/or

c_{1.5}) (J), (C)(i) and (C)(ii) and/or

c_{1.6}) (J), (E)(i), (E)(ii) and (D)(i) and/or

c_{1.7}) (E)(i), (E)(ii) and (U)(i) and/or

c_{1.8}) (E)(i), (E)(ii) and (U)(ii) and/or

c_{1.9}) (E)(i), (E)(ii) and (U)(iii),

if desired a catalyst component (R), if desired a solvent component (S)(i) and if desired a solvent component (S)(ii) being present besides the pure stabilizing component (T),

and a hydrophilic silane component (V) is prepared through

c_{1.10}) use of component (E)(iii) and/or reaction of the components

c_{1.11}) (G)(i), (G)(ii), (G)(iii), (G)(iv), (C)(i) and (C)(ii) and/or

c_{1.12}) (G)(i) and (G)(ii) (G)(iii) (G)(iv), (E)(i) (E)(ii) and (D)(i) and/or

c_{1.13}) (G)(ii), (G)(iv), (N)(i) and (N)(ii) and/or

c_{1.14}) (G)(i), (G)(ii), (E)(i), (E)(ii) and (D)(ii) and/or

c_{1.15}) (G)(i), (G)(ii), (E)(i), (E)(ii) and (H),

if desired a catalyst component (R), if desired a solvent component (S)(i) and if desired a solvent component (S)(ii) being present besides the pure hydrophilic silane component (V),

the fluorosilane component (A) from stages a) or b), the stabilizing component (T) and the hydrophilic silane component (V) from stage c), the solvent component (S)(i) and/or (S)(ii) being partly or completely removed before, during or after the reaction and/or mixing by distillation, and if desired the catalyst component (R) being partly or completely removed from stage c) before, during or after the reaction and/or mixing by suitable absorption materials or other measures, such that at most 0 to 1.2 parts by weight (including all values and subvalues therebetween) of a catalyst component (R), 0 to 50 parts by weight (including all values and subvalues therebetween) of a solvent component (S)(i) and 999.892 to 288.8 parts by weight (including all values and subvalues therebetween) of a solvent component (S)(ii) are present, are reacted with an activator component (X) containing an acid component (U)(v), if desired a solvent component (S)(ii) and/or water.

If desired, e), during or after stages a) and/or b) and/or c) and/or d), a formulation component (Y)(i) can be added and/or a functionalization component (Z), consisting of the components

e₁) (E)(iv) and/or

e₂) (E)(v) and/or

e₃) (E)(vi) and/or

e₄) (Y)(ii),

can be added and/or co-reacted.

In a further process variant, components (A)(i) from reaction stage a) and (V) from reaction stage c) are prepared and/or mixed simultaneously.

The present invention likewise covers using the fluorine-containing compositions or (per)fluoroalkyl-functional organosilanes according to reaction stages a) and b) likewise in single-component form, such as the fluorine-containing compositions or (per)fluoroalkyl-functional organopolysiloxane precondensates or (per)fluoroalkyl-functional organosiloxane condensates according to reaction stages c) and d).

As regards the reaction temperatures, it is proposed to carry out reaction stage a) at a temperature of from 40 to 120° C., preferably at 50 to 110° C., and reaction stages b) to e) at a temperature of from 20 to 120° C., preferably at 50 to 10° C.

The solid-body content of the fluorine-containing compositions consisting of components (A), (Y)(i) and (Z) should be adjusted to 5 to 100% by weight (including all values and subvalues therebetween), preferably to 100% by weight (including all values and subvalues therebetween), in reaction stages a) and b). The solid-body content of the fluorine containing compositions comprising components (A), (U)(v), (T), (V), (Y)(i) and (Z) is adjusted to 0.001 to 10% by weight (including all values and subvalues therebetween), preferably to 0.005 to 5% by weight (including all values and subvalues therebetween) and particularly preferably to 0.1 to 1.5% by weight (including all values and subvalues therebetween), in reaction stage d).

For reaction stages d), the present invention envisages pH values of the fluorine-containing compositions which, independently of one another, have been adjusted to 1 to 14, preferably to 2 to 6 and particularly preferably to 3 to 5.

Finally, the present invention further provides the use of the fluorine-containing compositions according to the invention in the construction or industrial sector for the permanent oil-, water- and soil-repellent surface treatment or modification of mineral and non-mineral substrates, such as, for example,

inorganic surfaces,
such as, for example, porous and nonporous, absorbent and nonabsorbent, rough and polished building materials and construction materials and building materials of all types based on cement (concrete, mortar), limestone, gypsum, anhydrite, geopolymers, silica and silicates, artificial stone, natural stone (such as, for example, granite, marble, sandstone, slate, serpentine), clay and also enamel, fillers and pigments, glass and glass fibres, ceramics, metals and metal alloys,

organic surfaces,
such as, for example, fabric and textiles, wood and timber products, rubber, wood veneer, glass-fibre reinforced plastics (GFP), plastics, leather and imitation leather, natural fibers, paper, polymers of all types,

composite materials of all types, if desired, with nanoscale constituents.

The fluorine-containing compositions according to the invention are in particular also suitable for permanent oil-, water- and soil-repellent surface treatment or modification and here primarily in the on-site and/or off-site sector of construction and industry, such as, for example, for the applications

hydrophobicization and oleophobicization

antigraffiti

antisoiling

easy-to-clean

low dirt pick-up

nanostructured surfaces with Lotus Effect®

building protection

corrosion protection

seals

coatings

impregnations

sealings.

Furthermore, the fluorine-containing compositions according to the invention in the specified sector of construction and industry (on-site and/or off-site) are suitable for the following fields of application:

additives for paint and coating systems

automobile and automotive industry

precast concrete parts

moulded concrete parts
poured-in-place concrete
air-placed concrete
ready-mixed concrete

roof tiles

electro and electronics industry

paints and coatings

tiles and joints

fabric and textiles

glass facades and glass surfaces
wood-working and processing (veneers, impregnation)

ceramics and sanitary ware

adhesives and sealants

corrosion protection

noise protection walls

plastic films

leather dressing

surface modification of fillers, pigments, nanoparticles

paper and board coating

plasters and decorating plasters

thermal insulation composite systems (TICS) and thermal insulation systems (TIS)

cement-bonded fibreboards.

In this connection, the suitability of the fluorine-containing compositions for the mass hydrophobicization/oleophobicization of concrete in the construction or industrial sector (on-site and/or off-site), should be emphasized, such as, for example,

job-mix concrete

concrete products (precast concrete parts, concrete ware, concrete cast stones)

poured-in-place concrete

air-placed concrete

ready-mixed concrete.

Furthermore, the fluorine-containing compositions according to the invention are exceptionally suitable as monomers or macromonomers for sol-gel systems.

The (per)fluoroalkyl-functional organopolysiloxane condensates according to the invention can thus be used in an exceptional manner as agents for the hydrophobicization and/or oleophobicization of surfaces, as building protectants, as agents for the treatment of concrete, of natural mineral substances and also of glazed and unglazed ceramic products, as additive in preparations for surface treatment, for “anti-graffiti” applications, and in compositions for “anti-graffiti” applications, for “easy-to-clean” applications and in compositions for “easy-to-clean” applications, as water-soluble adhesion promoter, as constituent in coating systems, and in corrosion protection compositions, for the biocidal finishing of surfaces, for the treatment of wood, for the treatment of leather, leather products and furs, for the treatment of glass surfaces, for the treatment of flat glass, for the treatment of plastic surfaces, for the production of pharmaceutical and cosmetic products, for the modification of glass and mineral surfaces, and glass and mineral fibre surfaces, for the production of artificial stones, for the treatment of waste water, for the surface modification and treatment of pigments, and also as constituent in paints and coatings.

The application of the (per)fluoroalkyl-functional organopolysiloxane condensates according to the invention can take place from a 50% strength solution or a dilute solution, it being possible to use water, for example, as diluent. In principle, it is also possible to dilute the composition according to the invention with a corresponding alcohol.

Moreover, the claimed (per)fluoroalkyl-functional organopolysiloxane condensates bring about an again improved beading behaviour of a correspondingly treated, mineral surface—both using hydrophilic and hydrophobic standard test liquids (tests according to “TEFLON® Specification Test Kit” from DuPont de Nemours). At this point, reference is made to the examples.

The compositions according to the invention are advantageously used in an amount of from 0.00001 to 1 kg per m² of the surface to be coated and per operation.

In general, the application of the claimed compositions can take place using the methods known from coating technology, such as, for example, flooding, pouring, HVLP (high volume-low pressure) process, application with a doctor blade, roller coating with a soft roller, spraying, brushing, immersion and roller coating with a hard roller.

On account of their oligomeric structure, the fluorine-containing compositions according to the invention preferably contain a high concentration of silanol functions which equip them in an excellent manner for the reaction with hydroxyl-group-containing substrate surfaces. Coatings and impregnations with diverse substrates exhibit excellent oil-repellent and simultaneously water-repellent properties, even after thermal treatment, treatment with surfactants and UV treatment. In addition, in corresponding experiments, it was demonstrated on various substrates that even after >6 months no reduction in the effectiveness or destabilization of the fluorine-containing compositions according to the invention was evident. Upon using the fluorine-containing compositions according to the invention, it is possible to achieve at the same time a hydrophobicizing, oleophobicizing, soil-repellent and dye-repellent effect on the most diverse of substrate surfaces in a simple and excellent manner.

The drying and curing of the coatings produced from the compositions according to the invention generally takes place at normal (outside and inside) temperatures in the range from 0 to 50° C., i.e. without special heating of the coatings. Depending on the application, however, it is also just as likely for this to take place at higher temperatures up to 150° C.

### Overview of Components DCO Y

| | |
|---|---|
| (A)(i) | fluorosilane component |
| (A)(ii) | preprepared fluorosilane component |
| (B)(i) | (per)fluoroalkyl alcohol component |
| (B)(ii) | (per)fluoroalkylalkylenamine component |
| (B)(iii) | fluorine-modified macromonomers or telechels |
| (B)(iv) | (per)fluoroalkylalkylene isocyanate component |
| (B)(v) | (per)fluoroalkylcarboxylic acid derivative component |
| (C)(i) | isocyanatoalkylalkoxysilane component |
| (C)(ii) | other isocyanatosilane component |
| (D)(i) | polyisocyanate component |
| (D)(ii) | polyisocyanate component |
| (E)(i) | aminoalkylalkoxysilane component |
| (E)(ii) | other aminosilane component |
| (E)(iii) | nonionic silane component |
| (E)(iv) | aminosilicone oil component |
| (E)(v) | low molecular weight silane component |
| (E)(vi) | hydrophilized aqueous silane component |
| (F)(i) | monofunctional hexafluoropropene oxide component |
| (F)(ii) | difunctional hexafluoropropene oxide component |
| (G)(i) | monofunctional polyalkylene glycol component |
| (G)(ii) | monofunctional polyoxyalkylenamine component |
| (G)(iii) | polyfunctional polyalkylene glycol component |
| (G)(iv) | polyfunctional polyoxyalkylenamine component |
| (H) | triazine component |
| (I) | hydroxycarboxylic acid component |
| (J) | NCN component |
| (K) | carbonyl component |
| (L)(i) | mercaptoalkylalkoxysilane component |
| (L)(ii) | other mercaptosilane component |
| (M) | (per)fluoroalkylalkylene oxide component |
| (N)(i) | epoxyalkylolalkoxysilane component |
| (N)(ii) | other epoxysilane component |
| (O) | polyamine component |
| (P)(i) | epoxy-functional polyhedral oligomeric |
| | polysilsesquioxane component |
| (P)(ii) | amino-functional polyhedral oligomeric |
| | polysilsesquioxane component |
| (P)(iii) | (meth)acryloyl-functional polyhedral oligomeric |
| | polysilsesquioxane component |
| (Q)(i) | amino alcohol component |
| (Q)(ii) | other amino alcohol component |
| (R) | catalyst component |
| (S)(i) | solvent component |
| (S)(ii) | solvent component |
| (T) | stabilizing component |
| (U)(i) | acid component |
| (U)(ii) | acid component |
| (U)(iii) | acid component |
| (U)(iv) | acid component |
| (V) | hydrophilic silane component |
| (W) | neutralization component |
| (Y)(i) | formulation component |
| (Y)(ii) | (reactive) nanoparticle component |
| (Z) | functionalization component |

Having generally described this invention, a further understanding can be obtained by reference to certain specific examples which are provided herein for purposes of illustration only, and are not intended to be limiting unless otherwise specified.

### EXAMPLES

### Chemicals Used

FLUOWET® EA 612: fluoroalcohol mixture from Clariant GmbH
FLUOWET® EA 812 AC: fluoroalcohol mixture from Clariant GmbH
Daikin A-1820: fluoroalcohol from Daikin Industries Ltd.
SILQUEST® A-1230 Silane: polyether-modified alkoxysilane from GE-Silicones
HFPO oligomer methyl ester: monofunctional polyhexafluoropropene oxide carboxylic acid methyl ester from Dyneon GmbH & Co. KG
DYNASILAN® AMEO: 3-aminopropyltriethoxysilane from Degussa GmbH
DYNASILAN® AMMO: 3-aminopropyltrimethoxysilane from Degussa GmbH
DYNASILAN® TRIAMO: N—[N′-(2-aminoethyl)-2-aminoethyl]-3-aminopropyl-trimethoxysilane from Degussa GmbH
MPEG 300, 500, 1000: monohydroxyfunctional methyl polyethylene glycol of molar mass 300, 500, 1000 g/mol
DBTL: dibutyltin dilaurate

### Example 1

### Fluorosilane (1)

A mixture of 200.00 g (561.96 mmol) of FLUOWET® EA 612 and 143.31 g (561.98 mmol) of 3-(triethoxysilyl)propyl isocyanate was initially introduced in a 500 ml three-necked round-bottomed flask with internal thermometer, precision-ground glass stirrer and Dimroth condenser. After adding 0.34 g of DBTL as catalyst, the reaction mixture was heated to 55° C. and stirred at this temperature for about 2 h until the reaction was complete. The product obtained was a viscous liquid with partial solids fraction and a residual NCO content of 0.18% by weight.

Isocyanate content: calculated: 0% by weight, found: 0.18% by weight

### Example 2

### Fluorosilane (2)

44.00 g (84.42 mmol) of FLUOWET® EA 812 AC were initially introduced into 0.07 g of DBTL as catalyst at 70° C. in a 100 ml three-necked, round-bottomed flask with internal thermometer, dropping funnel, air cooler and stirring magnet. At this temperature, 21.75 g (84.41 mmol) of 3-(triethoxysilyl)propyl isocyanate were added dropwise over a period of 1 h. To complete the reaction, the mixture was afterstirred for a further 2 h at room temperature. The product obtained was a viscous liquid with partial solids fraction and a residual NCO content of 0.08% by weight.

Isocyanate content: calculated: 0% by weight, found: 0.08% by weight

This fluorosilane was not further processed.

### Example 3

### Fluorosilane (3)

100 g of HFPO oligomer methyl ester (Mₙ=1008 g/mol, 0.099 mol) were initially introduced in a 250 ml three-necked round-bottomed flask equipped with dropping funnel, precision-ground glass stirrer and reflux condenser. With stirring, 17.75 g of DYNASILAN® AMMO (M=179.29 g/mol, 0.099 mol) were slowly metered in and the mixture was afterstirred for 30 min. To complete the reaction, the mixture was then stirred for a further 3 h at 60° C. and the hydrolysis alcohol which formed was distilled off in vacuo. The product obtained was a colorless, slightly viscous liquid. This product was not further processed.

### Example 4

### Stabilizing Component

The synthesis of the polyhydroxylsilane (“sugar silane”) used as hydrophilic stabilizing component is carried out in accordance with already published preparation instructions (e.g. Patent Specification DE 3600714 C2):

A solution of 62.14 g of DYNASILAN® AMEO (M=221.37 g/mol, 280.7 mmol) in 150 ml of absolute ethanol is metered into a suspension of 100.01 g of δ-gluconolactone (M=178.14 g/mol, 280.7 mmol) in 250 ml of absolute ethanol with stirring and the mixture is briefly afterstirred. To complete the reaction, the clear solution is refluxed for a further 60 min. After distilling off the solvent on the rotary evaporator, a clear, water-soluble solid is obtained as product.

### Example 5

### Hydrophilic Silane Components

Hydrophilic silane components used are primarily alkoxysilanes modified with polyethylene glycol. As commercial products, DYNASILAN® 4140 (4140-A) and SILQUEST® A-1230 silane were used.

### Examples 6-12

### Two-Component Fluorosilanes

A mixture of fluorosilane (from Example 1), aqueous hydrochloric acid (1 mol/l), ethanol, isopropanol, SILQUEST® A-1230 Silane, polyhydroxylsilane (from Example 4) and water were stirred in a beaker at room temperature for 1 h according to Table 1. The activated fluorosilane mixture obtained was a homogeneous, colourless solution.

TABLE 1
Examples 6-12: Two-component fluorosilanes

| | Component 1 | | | | Component 2 | | |
|---|---|---|---|---|---|---|---|
| | Fluorosilane | | SILQUEST ® | Polyhydroxylsilane | | Hydrochloric acid | |
| Ex. | (Ex. 1) | Ethanol | A-1230 Silane | (Ex. 4) | Water | (1 mol/l) | Isopropanol |
| 6 | 20 g | 980 g | — | | 450 g | 3.4 g | 550 g |
| 7 | 35 g | 965 g | — | | 450 g | 3.4 g | 550 g |
| 8 | 35 g | 965 g | 20.2 g | | 450 g | 3.4 g | 550 g |
| 9 | 35 g | 965 g | 40.8 g | | 450 g | 3.4 g | 550 g |
| 10 | 35 g | 965 g | 20.2 g | 2.02 g | 450 g | 3.4 g | 550 g |
| 11 | 35 g | 965 g | 20.2 g | 4.04 g | 450 g | 3.4 g | 550 g |
| 12 | 25 g | 965 g | 20.2 g | 6.06 g | 450 g | 3.4 g | 550 g |

### Examples 13-18

### Fluorosilanes

A mixture of FLUOWET® EA 612, MPEG and 3-(triethoxysilyl)propyl isocyanate according to Table 2 was initially introduced in a 500 ml three-necked round-bottomed flask with internal thermometer, precision-ground glass stirrer and reflux condenser. After adding about 0.1% by weight of DBTL as catalyst, the reaction mixture was heated to 70° C. and stirred for about 2-6 h until all of the isocyanate groups had completely reacted. In all cases, the product mixtures obtained were viscous liquids/suspensions with residual NCO concentrations of less than 0.2% by weight. For further stabilization, a polyhydroxylsilane according to Example 4 was then added.

### Example 13-18

### Fluorosilanes

| Ex. | SILQUEST ® A-Link 25 Silane | Daikin A-1820 | MPEG | Polyhydroxylsilane (Ex. 16) |
|---|---|---|---|---|
| 13 | 15.14 g (61.2 mmol) | 9.38 g (20.2 mmol) | 12.25 g MPEG 300 | — |
| | | | (M = 300 g/mol, 41.0 mmol) | |
| 14 | 15.14 g (61.2 mmol) | 9.38 g (20.2 mmol) | 12.25 g MPEG 300 | 0.37 g (M = 399.51 g/mol, 0.9 mmol) |
| | | | (M = 300 g/mol, 41.0 mmol) | |
| 15 | 15.14 g (61.2 mmol) | 14.20 g (30.6 mmol) | 9.18 g MPEG 300 | 0.39 g (M = 399.51 g/mol, 1.0 mmol) |
| | | | (M = 300 g/mol, 30.6 mmol) | |
| 16 | 15.14 g (61.2 mmol) | 19.03 g (41.0 mmol) | 6.06 g MPEG 300 | 0.40 g (M = 399.51 g/mol, 1.0 mmol) |
| | | | (M = 300 g/mol, 20.2 mmol) | |
| 17 | 15.14 g (61.2 mmol) | 19.03 g (41.0 mmol) | 10.1 g MPEG 500 | 0.89 g (M = 399,51 g/mol, 1.8 mmol) |
| | | | (M = 500 g/mol, 20.2 mmol) | |
| 18 | 15.14 g (61.2 mmol) | 19.03 g (41.0 mmol) | 20.2 g MPEG 1000 | 2.72 g (M = 399,51 g/mol, 6.8 mmol) |
| | | | (M = 1000 g/mol, 20.2 mmol) | |

### Example 13

### Coating

The coating operation was carried out by immersion, roller coating, brushing and rubbing in of the cleaned substrate with the activated fluorosilane mixture. After a contact time of 30 min, the substrate surface was cleaned from dried-in residues by polishing with a soft cloth. Separate aftertreatment was not carried out.

European patent application EP08101211 filed Feb. 1, 2008, is incorporated herein by reference.

Numerous modifications and variations on the present invention are possible in light of the above teachings. It is therefore to be understood that within the scope of the appended claims, the invention may be practiced otherwise than as specifically described herein.

1. A liquid, fluorine-containing and two component composition for the permanent surface treatment of porous and nonporous substrates, comprising:
a solid resin,
a fluorine content, based on the solid resin, of from 5 to 75% by weight,
wherein said composition is obtained by firstly
a) preparing a fluorosilane component (A)(i) with a polymerically bonded fluorine content of from 5 to 95% by weight and a polymerically bonded silicon content of from 95 to 5% by weight, by reacting
a₁) 5 to 95% by weight of a (per)fluoroalkyl alcohol component (B)(i) and/or a (per)fluoroalkylalkylenamine component (B)(ii), comprising perfluoroalkyl alcohols with terminal methylene groups (hydrocarbon spacers) of the general formula
CF₃—(CF₂)ₓ—(CH₂)_{y}—O-A_{z}-H
or
CR₃—(CR₂)ₓ—(CH₂)_{y}—O-A_{z}-H
in which x=3-20, y=1-6, z=0-100, R=independently of one another H, F, CF₃, A=CRⁱRⁱⁱ—CRⁱⁱⁱR^{iv}—O or (CRⁱRⁱⁱ)ₐ—O or CO—(CRⁱRⁱⁱ)_{b}—O where Rⁱ, Rⁱⁱ, Rⁱⁱⁱ, R^{iv}=independently of one another H, alkyl, cycloalkyl, aryl or any desired organic radical having in each case 1-25 carbon atoms, a, b=3-5, where the polyalkylene oxide structural unit A_{z} is homopolymers, copolymers or block copolymers of any desired alkylene oxides or is polyoxyalkylene glycols or polylactones,
and/or
a hexafluoropropene oxide (HFPO) oligomer alcohol of the general formula
CF₃—CF₂—CF₂—[O—CF(CF₃—CF₂]ₓ—O—CF(CF₃)—(CH₂)_{y}—O-A_{z}-H
and/or
a fluorine-modified macromonomer or telechel (B)(iii), such as, for example, hydroxy-functional reaction products of components (F)(i) and (F)(ii) with components (Q)(i) and (Q)(ii), having a polymerically bonded fluorine content of from 1 to 99% by weight, a molecular mass of from 100 to 10 000 daltons and in each case one or more reactive (cyclo)aliphatic and/or aromatic hydroxyl group(s) and/or primary and/or secondary amino group(s) and/or mercapto group(s), containing the structural elements arranged intrachemically and/or laterally and/or terminally in the main chain and/or side chain
—(CF₂—CF₂)ₓ—
and/or
—(CR₂—CR₂)ₓ—
and/or
[CF₂—CF(CF₃)—O]ₓ—
and/or
—(CR₂—CR₂—O)ₓ—
with 95 to 5% by weight of an isocyanatoalkylalkoxysilane component (C)(i), comprising a 3-isocyanatopropyltrialkoxysilane and/or a 3-isocyanatopropylalkoxyalkylsilane and/or isocyanatoalkylalkoxysilanes of the general formula
OCN—(CR²₂)_{y′}—Si(OR¹)_{3-x′}R²_{x′}
in which x′=0-2, y′=1-3 and R¹, R²=independently of one another alkyl, cycloalkyl, aryl, any desired organic radical in each case having 1-25 carbon atoms;
0 to 10 parts by weight of a catalyst component (R) and 0 to 250 parts by weight of a solvent component (S)(i) being present besides 2.5 to 250 parts by weight of the pure fluorosilane component (A),
b₁) optionally, partially or completely removing the solvent component (S)(i) from stage a) before, during or after the reaction by distillation,
b₂) optionally, partially or completely removing the catalyst component (R) from stage a) after the reaction through suitable absorption materials or other measures,
b₃) dissolving the mixture from stage a) before, during or after the reaction in 0 to 250 parts by weight of a solvent component (S)(ii),
c₁) optionally, (partially) hydrolysing with 0.25 to 25 parts by weight of water or silanolizing the mixture from stages a) or b) with 0 to 100 parts by weight of an aminosilane component (E)(i) and/or (E)(ii) and 0.1 to 100 parts by weight of a stabilizing component (T), comprising the
c_{1.1}) reaction products of 5 to 95% by weight of an amino alcohol component (Q)(i) and/or another amino alcohol component (Q)(ii) and 95 to 5% by weight of an isocyanatosilane component (C)(i) and/or (C)(ii),
and/or
c_{1.2}) reaction products of 5 to 75% by weight of an amino alcohol component (Q)(i) and/or another amino alcohol component (Q)(ii), 75 to 5% by weight of an aminosilane component (E)(i) and/or (E)(ii) and 75 to 5% by weight of a polyisocyanate component (D)(i),
and/or
c_{1.3}) reaction products of 5 to 95% by weight of a hydroxycarboxylic acid component (I) and 95 to 5% by weight of an isocyanatosilane component (C)(i) and/or (C)(ii),
and/or
c_{1.4}) reaction products of 5 to 75% by weight of a hydroxycarboxylic acid component (I), 75 to 5% by weight of an aminosilane component (E)(i) and/or (E)(ii) and 75 to 5% by weight of a polyisocyanate component (D)(i),
and/or
c_{1.5}) reaction products of 5 to 95% by weight of an NCN component (J) and 95 to 5% by weight of an isocyanatosilane component (C)(i) and/or (C)(ii),
and/or
c_{1.6}) reaction products of 5 to 75% by weight of an NCN component (J), 75 to 5% by weight of an aminosilane component (E)(i) and/or (E)(ii) and 75 to 5% by weight of a polyisocyanate component (D)(i),
and/or
c_{1.7}) reaction products of 5 to 95% by weight of an aminosilane component (E)(i) and/or (E)(ii) and 95 to 5% by weight of an acid component (U)(i), comprising unsaturated carboxylic acids,
and/or
c_{1.8}) reaction products of 5 to 95% by weight of an aminosilane component (E)(i) and/or (E)(ii) and 95 to 5% by weight of an acid component (U)(ii), comprising unsaturated carboxylic acid anhydrides,
and/or
c_{1.9}) reaction products of 5 to 95% by weight of an aminosilane component (E)(i) and/or (E)(ii) and 95 to 5% by weight of an acid component (U)(iii), comprising γ- and/or δ-lactones of aldonic acids and/or sugar acids and/or polyhydroxy(di)carboxylic acids and/or polyhydroxycarboxaldehydes, and giving hydrophilic silanes of the general formula
(E)-CO—[CH(OH)₄]—CH₂OH
and/or
(E)-CO—[CH(OH)₄]—CHO
and/or
(E)-CO—[CH(OH)₄]—CO-(E),
the reaction products according to c_{1.1}) to c_{1.9}) containing 0 to 10 parts by weight of a catalyst component (R), 0 to 250 parts by weight of a solvent component (S)(i) and 0 to 250 parts by weight of a solvent component (S)(ii),
and 0.1 to 100 parts by weight of a hydrophilic silane component (V) comprising
c_{1.10}) a nonionic silane component (E)(iii) of the general formula
R¹¹—O-A_{z′}-(CH₂)_{y′}—Si(OR¹)_{3-x′}R²_{x′}
and/or
HO-A_{z′}-(CH₂)_{y′}—Si(OR¹)_{3-x′}R²_{x′}
in which R¹¹=alkyl, cycloalkyl, aryl, any desired organic radical having in each case 1-25 carbon atoms,
and/or
c_{1.11}) the reaction products of 5 to 95% by weight of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv) and 95 to 5% by weight of an isocyanatosilane component (C)(i) and/or (C)(ii),
and/or
c_{1.12}) the reaction products of 5 to 75% by weight of a monofunctional polyalkylene glycol component (G)(i) and/or a monofunctional polyoxyalkylenamine component (G)(ii) and/or a polyfunctional polyalkylene glycol component (G)(iii) and/or a polyfunctional polyoxyalkylenamine component (G)(iv), 75 to 5% by weight of an aminosilane component (E)(i) and/or (E)(ii) and 75 to 5% by weight of a polyisocyanate component (D)(i),
and/or
c_{1.13}) the reaction products of 5 to 95% by weight of a polyoxyalkylenamine component (G)(ii) and/or a polyfunctional polyoxyalkylenamine component (G)(iv) and 95 to 5% by weight of an epoxyalkylolalkoxysilane component (N)(i) and/or an epoxysilane component (N)(ii) different from (N)(i),
and/or
c_{1.14}) the reaction products of 5 to 75% by weight of a monofunctional polyalkylene glycol component (G)(i) and/or a monofunctional polyoxyalkylenamine component (G)(ii), 50 to 5% by weight of an aminosilane component (E)(i) and/or (E)(ii) and 50 to 5% by weight of a polyisocyanate component (D)(ii),
and/or
c_{1.15}) the reaction products of 5 to 75% by weight of a monofunctional polyalkylene glycol component (G)(i) and/or a monofunctional polyoxyalkylenamine component (G)(ii), 50 to 5% by weight of an aminosilane component (E)(i) and/or (E)(ii) and 50 to 5% by weight of a triazine component (H), comprising cyanuric chloride and/or 2,4,6-trichloro-1,3,5-triazine,
the reaction products according to c_{1.10}) to c_{1.15}) containing 0 to 10 parts by weight of a catalyst component (R), 0 to 250 parts by weight of a solvent component (S)(i) and 0 to 250 parts by weight of a solvent component (S)(ii),
c₂) optionally, partially or completely neutralizing the (amino-functional) adduct with 0 to 75 parts by weight of an acid component (U)(iv) or with 0 to 75 parts by weight of another neutralization component (W),
c₃) optionally, partially or completely removing the liberated alcohol and/or the solvent components (S)(i) and/or (S)(ii) before, during or after the reaction by distillation,
d) reacting 50 to 950 parts by weight of a mixture of 0.1 to 300 parts by weight of the fluorosilane component (A) from stages a) or b), optionally, 0.004 to 120 parts by weight of the stabilizing component (T) from stage c), optionally, 0.004 to 120 parts by weight of the hydrophilic silane component (V) from stage c), the solvent components (S)(i) and/or (S)(ii) being partially or completely removed before, during or after the reaction and/or mixing by distillation and, optionally, the catalyst component (R) being partially or completely removed before, during or after the reaction and/or mixing by suitable absorption materials or other measures, such that at most 0 to 1.2 parts by weight of a catalyst component (R), 0 to 50 parts by weight of a solvent component (S)(i) and 999.892 to 288.8 parts by weight of a solvent component (S)(ii) are present, with 950 to 50 parts by weight of an activator component (X) containing 0.01 to 10% by weight of an acid component (U)(v), 0 to 99.999% by weight of a solvent component (S)(ii) and/or 0 to 99.99% by weight of water,
e) optionally, 0 to 50 parts by weight or 0 to 60 parts by weight of a formulation component (Y)(i) being added during or after stages a) and/or b) and/or c) and/or d) in any desired manner and/or 0 to 50 parts by weight or 0 to 60 parts by weight of a functionalization component (Z), comprising
e₁) an aminosilicone oil component (E)(iv) of the general formula
HO—[Si(CH₃)₂—O]_{c}—Si(CH₃)[(CH₂)₃NH(CH₂)₂NH₂]—O—[Si(CH₃)₂—O]_{c}—H
or
R′O—[Si(CH₃)₂—O]_{c}—Si(CH₃)[(CH₂)₃NH(CH₂)₂NH₂]—O—[Si(CH₃)₂—O]_{c}—R′
or
(H₃CO)₂Si[(CH₂)₃NH(CH₂)₂NH₂]—[Si(CH₃)₂—O]_{c}—Si[(CH₂)₃NH(CH₂)₂NH₂](OCH₃)₂
in which c=1-100 and R′═H, Me, Et
and/or
e₂) a low molecular weight silane component (E)(v) of the general formula
R¹²—Si(OR¹)_{3-x′}R²_{x′}
in which R¹²═OR¹, R², independently of one another alkyl, cycloalkyl, aryl, any desired organic radical having 1-25 carbon atoms
and/or
e₃) a hydrophilized aqueous silane component (E)(vi) comprising (alcohol-free) aminosilane hydrolysates and/or (di/tri)amino/alkyl-functional siloxane-co-oligomers and/or amino/vinyl-functional siloxane-co-oligomers and/or epoxy-functional siloxane-co-oligomers
and/or
e₄) a (reactive) nanoparticle component (Y)(ii), comprising inorganic and/or organic nanoparticles or nanocomposites in the form of primary particles and/or aggregates and/or agglomerates, it being possible, optionally, for the nanoparticles to be hydrophobicized and/or doped and/or coated and additionally surface-modified with reactive amino groups and/or hydroxyl groups and/or mercapto groups and/or isocyanato groups and/or epoxy groups and/or methacryloyl groups and/or silane groups of the general formula —Si(OR¹)_{3-x′}R²_{x′},
being added and/or co-reacted.

2. The composition according to claim 1, wherein 3-isocyanatopropyltrimethoxysilane and/or 3-isocyanatopropyltriethoxysilane is used as component (C)(i).

3. The composition according to claim 1, wherein isophorone diisocyanate and/or toluene diisocyanate is used as component (D)(i).

4. The composition according to claim 1, wherein an optionally hydrophilically modified trimer of 1,6-diisocyanatohexane is used as component (D)(ii).

5. The composition according to claim 1, wherein 3-aminopropyltrimethoxysilane and/or 3-aminopropyltriethoxysilane and/or N-(2-aminoethyl)-3-aminopropyltrimethoxysilane and/or N-(2-aminoethyl)-3-aminopropyltriethoxysilane and/or N—[N′-(2-aminoethyl)-2-aminoethyl]-3-aminopropyltrimethoxysilane as component (E)(i), and silanes of the general formula
H₃C—O—(CH₂CH₂—O)_{z′}—(CH₂)₃—Si(OR¹)₃
in which z′=5-15 and R¹=Me, Et
are used as component (E)(iii).

6. The composition according to claim 1, wherein citric acid and/or hydroxypivalic acid and/or dimethylolpropionic acid is used as component (I).

7. The composition according to claim 1, wherein phosgene and/or ethyl chloroformate and/or diethyl carbonate and/or chloroformates and/or phosgene derivatives of components (B)(i) and/or (B)(ii) and/or (B)(iii) and/or carbamates of components (E)(i) and/or (E)(ii) are used as component (K).

8. The composition according to claim 1, wherein 3-mercaptopropyltrimethoxysilane and/or 3-mercaptopropyltriethoxysilane is used as component (L)(i).

9. The composition according to claim 1, wherein 4,4,5,5,6,6,7,7,8,8,9,9,9-tridecafluorononene 1,2-oxide and/or 4,4,5,5,6,6,7,7,8,8,9,9,10,10,11,11,11-heptadecafluoroundecene 1,2-oxide is used as component (M).

10. The composition according to claim 1, wherein 3-glycidyloxypropyltrimethoxysilane and/or 3-glycidyloxypropyltriethoxysilane is used as component (N)(i).

11. The composition according to claim 1, wherein ethylenediamine is used as component (O).

12. The composition according to claim 1, wherein diethanolamine and/or diisopropanolamine and/or trimethylolmethylamine and/or amino sugar is used as component (Q).

13. The composition according to claim 1, wherein dibutyltin oxide and/or dibutyltin dilaurate (DBTL) and/or triethylamine and/or tinn(II) octoate and/or 1,4-diazabicyclo[2.2.2]octane (DABCO) and/or 1,4-diazabicyclo[3.2.0]-5-nonene (DBN) and/or 1,5-diazabicyclo[5.4.0]-7-undecene (DBU) and/or morpholine derivatives such as, for example, JEFFCAT® Amine Catalysts are used as component (R).

14. The composition according to claim 1, wherein acetone and/or butanone and/or N-methyl-2-pyrrolidone and/or N-ethyl-2-pyrrolidone and/or dipropylene glycol dimethyl ether (Proglyde DMM®) are used as component (S)(i).

15. The composition according to claim 1, wherein methanol and/or ethanol and/or 2-propanol are used as component (S)(ii).

16. The composition according to claim 1, wherein acrylic acid is used as component (U)(i).

17. The composition according to claim 1, wherein maleic anhydride is used as component (U)(ii).

18. The composition according to claim 1, wherein D-gluconolactone is used as component (U)(ii).

19. The composition according to claim 1, wherein formic acid is used as component (U)(iv).

20. The composition according to claim 1, wherein hydrochloric acid is used as component (U)(v).

21. The composition according to claim 1, wherein triethylamine is used as component (W).

22. The composition according to claim 1, wherein (1) optionally functionalized, inorganic and/or organic fillers and/or light-weight fillers; (2) optionally functionalized, inorganic and/or organic pigments; (3) optionally functionalized, inorganic and/or organic carrier materials; (4) inorganic and/or organic fibres; (5) graphite; (6) carbon black; (7) carbon fibres; (8) carbon nanotubes; (9) metal fibres and metal powders; (10) conductive organic polymers; (11) further polymers and/or redispersible polymer powders; (12) superabsorbents; (13) further inorganic and/or organic compounds; (14) antifoams, deaerators; (15) lubricant and flow additives; (16) substrate wetting additives; (17) wetting and dispersion additives; (18) hydrophobicizing agents; (19) rheology additives; (20) coalescence auxiliaries; (21) matting agents; (22) adhesion promoters; (23) antifreezes; (24) antioxidants; (25) UV stabilizers; (26) biocides; (27) water; (28) solvents; or (29) catalysts are used as component (Y)(i).

23. The composition according to claim 1, wherein, optionally reactive, nanoparticles based on silicon dioxide and/or titanium dioxide and/or zinc oxide are used as component (Y)(ii), the nanoparticles being present in solid form and/or in the form of dispersions and/or pastes.

24. The composition according to claim 1, wherein at least 50% by weight of the total component (Y)(ii) have a particle size of at most 500 nm (standard: DIN 53206-1, Testing of pigments; particle size analysis, basic terms) and the totality of the particles which have this particle size of at most 500 nm have a specific surface area (standard: DIN 66131, Determination of the specific surface area of solids by gas adsorption according to Brunauer, Emmet and Teller (BET)) of from 10 to 200 m²/g.

25. The composition according to claim 1, wherein at least 70% by weight of the total component (Y)(ii) have a particle size of from 10 to 300 nm (standard: DIN 53206-1, Testing of pigments; particle size analysis, basic terms), and the totality of the particles which have this particle size of from 10 to 300 nm have a specific surface area (standard: DIN 66131, Determination of the specific surface area of solids by gas adsorption according to Brunauer, Emmet and Teller (BET)) of from 30 to 100 m²/g.

26. The composition according to claim 1, wherein the components (Y)(i) and (Y)(ii) are present in coated and/or microencapsulated and/or supported and/or hydrophilized and/or solvent-containing form and, optionally, are released slowly.

27. A process for the preparation of the composition according to claim 1, said process comprising:
a) a fluorosilane component (A)(i) is prepared by reacting the components
a₁) (B)(i), (B)(ii), (B)(iii) and (C)
optionally, a catalyst component (R) and optionally, a solvent component (S)(i) being present besides the pure fluorosilane component (A), then
b₁) optionally, the solvent component (S)(i) is partially or completely removed from stage a) before, during or after the reaction by distillation,
b₂) optionally, the catalyst component (R) is partially or completely removed from stage a) after the reaction by suitable absorption materials or other measures,
b₃) optionally, the fluorosilane component (A) from stage a) is dissolved before, during or after the reaction in the solvent component (S)(ii),
or
c₁) optionally, the fluorosilane component (A) from stages a) or b) is (partially) hydrolyzed with water or silanolized optionally, in the presence of an aminoalkylalkoxysilane component (E)(i) and/or an aminosilane component (E)(ii) and/or a stabilizing component (T) comprising reaction products of the components
c_{1.1}) (Q)(i), (Q)(ii), (C)(i) and (C)(ii) and/or
c_{1.2}) (Q)(i) (Q)(ii), (E)(i), (E)(ii) and (D)(i) and/or
c_{1.3}) (I), (C)(i) and (C)(ii) and/or
c_{1.4}) (I), (E)(i), (E)(ii) and (D)(i) and/or
c_{1.5}) (J), (C)(i) and (C)(ii) and/or
c_{1.6}) (J), (E)(i), (E)(ii) and (D)(i) and/or
c_{1.7}) (E)(i), (E)(ii) and (U)(i) and/or
c_{1.8}) (E)(i), (E)(ii) and (U)(ii) and/or
c_{1.9}) (E)(i), (E)(ii) and (U)(iii),
optionally, a catalyst component (R), optionally, a solvent component (S)(i) and optionally, a solvent component (S)(ii) being present besides the pure stabilizing component (T),
and a hydrophilic silane component (V) comprising
c_{1.10}) (E)(iii) and/or reaction products of the components
c_{1.11}) (G)(i), (G)(ii), (G)(iii), (G)(iv), (C)(i) and (C)(ii) and/or
c_{1.12}) (G)(i) and (G)(ii) (G)(iii) (G)(iv), (E)(i) (E)(ii) and (D)(i) and/or
c_{1.13}) (G)(ii), (G)(iv), (N)(i) and (N)(ii) and/or
c_{1.14}) (G)(i), (G)(ii), (E)(i), (E)(ii) and (D)(ii) and/or
c_{1.15}) (G)(i), (G)(ii), (E)(i), (E)(ii) and (H),
optionally, a catalyst component (R), optionally, a solvent component (S)(i) and optionally, a solvent component (S)(ii) being present besides the pure hydrophilic silane component (V),
c₂) the (amino-functional) adduct is partly or completely neutralized with an acid component (U)(iv) or with another neutralization component (W),
c₃) optionally, the liberated alcohol and/or the solvent components (S)(i) and/or (S)(ii) are partly or completely removed before, during or after the reaction by distillation,
d) the fluorosilane component (A) from stages a) or b), the stabilizing component (T) and the hydrophilic silane component (V) from stage c), the solvent component (S)(i) and/or (S)(ii) being partly or completely removed before, during or after the reaction and/or mixing by distillation, and optionally, the catalyst component (R) being partly or completely removed from stage c) before, during or after the reaction and/or mixing by suitable absorption materials or other measures, such that at most 0 to 1.2 parts by weight of a catalyst component (R), 0 to 50 parts by weight of a solvent component (S)(i) and 999.892 to 288.8 parts by weight of a solvent component (S)(ii) are present, are reacted with an activator component (X) containing an acid component (U)(v), optionally, a solvent component (S)(ii) and/or water,
e) optionally, a formulation component (Y)(i) being added during or after stages a) and/or b) and/or c) and/or d), and/or a functionalization component (Z), comprising the components
e₁) (E)(iv) and/or
e₂) (E)(v) and/or
e₃) (E)(vi) and/or
e₄) (Y)(ii),
being added and/or co-reacted.

28. The process according to claim 27, wherein the components (A)(i) from reaction stage a) and (V) from reaction stage c) are prepared and/or mixed simultaneously.

29. The process according to claim 28, wherein reaction stages c) and d) or b), c) and d) are combined in any desired manner and sequence.

30. The process according to claim 27, wherein, in stage b₃) a (partial) transesterification of the alkoxysilane groups of the fluorsilane component (A) with an alcoholic solvent solvent component (S)(ii) is additionally carried out.

31. The process according to claim 27, wherein the liberated alcohol and/or the solvent components (S)(i) and/or (S)(ii) in stage c₃) are removed by, optionally, azeotropic, distillation, then or simultaneously added again

32. The process according to claim 27, wherein the acid component (U)(iv) in stage c) is initially introduced together with the water.

33. The process according to claim 27, wherein the fluorine-containing compositions and/or (per)fluoroalkyl-functional organosilanes according to reaction stages a) and b) are used in single-component form.

34. The process according to claim 27, wherein the fluorine-containing compositions and/or (per)fluoroalkyl-functional organosiloxane precondensates and/or (per)fluoroalkyl-functional organosiloxane condensates according to reaction stages c) and d) are used in single-component form.

35. The process according to claim 27, wherein the fluorine-containing compositions and/or (per)fluoroalkyl-functional organosilanes according to reaction stage e) are used in two-component form.

36. The process according to claim 27, wherein in that reaction stage a) is carried out at a temperature of from 40 to 120° C.

37. The process according to claim 27, wherein reaction stages b) to e) are carried out at a temperature of from 20 to 120° C.

38. The process according to claim 27, wherein the equivalent ratio of fluorine atoms and nitrogen atoms in the reaction products of stages c) and d) is adjusted to 1:50 to 50:1.

39. The process according to claim 27, wherein the equivalent ratio of alkoxysilane groups and water in stage c) is adjusted to 1:10 to 10:1.

40. The process according to claim 27, wherein the molar ratio of silicon atoms and water in stage c) is adjusted to 1:10 to 10:1.

41. The process according to claim 27, wherein the solid-body content of the fluorine-containing compositions comprising components (A), (Y)(i) and (Z) in reaction stages a) and b) is adjusted to 5 to 100% by weight.

42. The process according to claim 27, wherein the solid-body content of the fluorine-containing compositions comprising the components (A), (E), (U)(iv), (T), (V), (Y)(i) and (Z) in reaction stage c) is adjusted to 25 to 100% by weight.

43. The process according to claim 27, wherein the solid-body content of the fluorine-containing compositions comprising the components (A), (E), (U)(iv), (T), (V), (Y)(i) and (Z) in reaction stage d) is adjusted to 0.001 to 100% by weight.

44. The process according to claim 27, wherein the pH of the fluorine-containing compositions in reaction stages c) and d) is adjusted to 1 to 14.

45. The process according to claim 27, wherein the Brookfield viscosity of the fluorine-containing compositions in reaction stages c) and d) is adjusted to 1 to 100 mPa·s.

46. A method of surface treatment or surface modification of a substrate, comprising: contacting said substrate with the composition according to claim 1.

47. The method of claim 46, wherein said surface treatment or modification is permanent oil-, water- and soil-repellent surface treatment or modification.

48. The method of claim 46, wherein said substrate is a mineral or a non-mineral substrate.

49. The method of claim 46, wherein said substrate comprises an inorganic surface, an organic surface, or a composite surface which is contacted with said composition.

50. The method according to claim 46, which is suitable for hydrophobicization, oleophobicization, antigraffiti, antisoiling, easy-to-clean, low dirt pick-up, nanostructured surfaces, building protection, corrosion protection, seals, coatings, impregnations or sealings.

51. A coating comprising the composition of claim 1.

52. A sol-gel system, comprising the composition of claim 1.

53. The method according to claim 46, wherein said composition is used in an amount of from 0.00001 to 1 kg pro m² of the surface to be coated and per operation.

54. The method according to claim 46, wherein the (per)fluoroalkyl-functional organosiloxane precondensates or (per)fluoroalkyl-functional organosiloxane condensates according to reaction stages c) and d) are applied using HVLP technology.
